(19) United States
(12) Patent Application Publication
(10) Pub. No.: US 2024/0229284 A1
(43) Pub. Date: Jul. 11, 2024

(54) SURFACE TREATED STEEL FOIL

(71) Applicant: TOYO KOHAN CO., LTD., Tokyo (JP)

(72) Inventors: Etsuro TSUTSUMI, Kudamatsu-shi, Yamaguchi (JP); Kyoko TAKANO, Kudamatsu-shi, Yamaguchi (JP); Shinichirou HORIE, Kudamatsu-shi, Yamaguchi (JP); Koh YOSHIOKA, Kudamatsu-shi, Yamaguchi (JP); Keishi KATSURA, Kudamatsu-shi, Yamaguchi (JP); Satoko HARADA, Kudamatsu-shi, Yamaguchi (JP); Misato UENO, Kudamatsu-shi, Yamaguchi (JP); Toshifumi KOYANAGI, Kudamatsu-shi, Yamaguchi (JP); Shunki OBATA, Kudamatsu-shi, Yamaguchi (JP)

(21) Appl. No.: 18/557,606

(22) PCT Filed: Apr. 28, 2022
(86) PCT No.: PCT/JP2022/019464

§ 371 Date: Oct. 27, 2023

(30) Foreign Application Priority Data
Apr. 28, 2021 (JP) 2021-076895

(51) Int. Cl. C25D 7/06; B32B 15/01; C25D 3/12; C25D 5/14; C25D 5/50; H01M 4/02; H01M 4/66

(52) U.S. Cl. CPC C25D 7/0614; B32B 15/011; B32B 15/015; C25D 3/12; C25D 5/14; C25D 5/50; H01M 4/662; H01M 4/667; H01M 2004/029

(57) ABSTRACT

[Object]

To provide a surface treated steel foil having hydrogen barrier properties suitable for a bipolar battery.

[Solving Means]

A surface treated steel foil having a first surface and a second surface located on a side opposite to the first surface, the surface treated steel foil including a base material composed of a low carbon steel or an ultra low carbon steel, and an iron-nickel alloy layer laminated on the base material on at least one surface side of the first surface side and the second surface side. Fe₁Ni₁ is included as an alloy phase in the iron-nickel alloy layer, an orientation index in X-ray diffraction of a (220) plane of Fe₁Ni₁ in the surface having the iron-nickel alloy layer is not less than 1.0, and the ratio of the maximum value of diffraction intensity of the (220) plane of Fe₁Ni₁ and the maximum value of diffraction intensity of a Fe(200) plane satisfies the following formula (1).

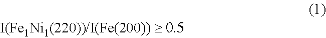

### TECHNICAL FIELD

The present invention relates to a surface treated steel foil to be used particularly suitably for a current collector of a secondary battery or the like.

### BACKGROUND ART

Conventionally, a nickel hydrogen battery and a lithium ion battery have been known as a secondary battery to be adopted for in-vehicle use or the like. As kinds of electrode of these secondary batteries, there are known a monopolar electrode in which positive electrode layers or negative electrode layers are formed on both surfaces of a current collector, and a bipolar electrode in which a positive electrode layer (positive electrode active material layer) and a negative electrode layer (negative electrode active material layer) are formed on both surfaces of a current collector.

A bipolar battery is configured by laminating the above-mentioned bipolar electrodes with an electrolyte, a separator, or the like interposed therebetween, and accommodating them in a single battery jar. With this configuration, the electrodes can be laminated in a series circuit, and hence, it is known that the internal resistance of the battery can be reduced, and it is easy to increase the working voltage and the output. In addition, together with battery performance, by omitting or reducing the number of members such as tab leads for taking out a current by battery design, the volume or weight of the battery can be reduced as compared to the conventional batteries using monopolar electrodes, and hence, it is considered that enhancement of a battery volume and weight energy density can be realized.

For example, PTL 1 mentioned below discloses use of a metallic foil such as a nickel foil as a current collector of a bipolar battery.

### CITATION LIST

### Patent Literature

### [PTL 1]

Japanese Patent Laid-open No. 2020-053401

### SUMMARY

### Technical Problem

In proceeding with development of a surface treated steel foil plated with nickel as a metallic foil suitable for battery use, the present inventors have found out that deterioration of battery performance can be suppressed by restraining permeation of hydrogen in the surface treated steel foil.

For example, in a nickel hydrogen battery, hydrogen, generally a hydrogen occluding alloy, is used as an active material on a negative electrode. In the conventional monopolar electrode, it has been sufficient to provide the surface of a battery material such as a current collector with liquid electrolyte resistance according to the kind of the battery, but in the case of the above-mentioned bipolar electrode, a phenomenon in which hydrogen present on the negative electrode side moves in the metallic material and permeates to the positive electrode side easily occurs, and when such a permeation phenomenon occurs, it is considered that battery performance is liable to be lowered.

The present invention has been made in consideration of such a problem, and it is an object of the present invention to provide a surface treated steel foil that has hydrogen barrier properties.

### Solution to Problem

In order to solve the problem exemplified above, a surface treated steel foil in one embodiment of the present invention is (1) a surface treated steel foil having a first surface and a second surface located on a side opposite to the first surface, the surface treated steel foil including a base material composed of a low carbon steel or an ultra low carbon steel and an iron-nickel alloy layer laminated on the base material on at least one surface side of the first surface side and the second surface side. Fe₁Ni₁ is contained as an alloy phase in the iron-nickel alloy layer, an orientation index in X-ray diffraction of a (220) plane of Fe₁Ni₁ in the surface having the iron-nickel alloy layer is not less than 1.0, and the ratio of the maximum value of diffraction intensity of the (220) plane of Fe₁Ni₁ and the maximum value of diffraction intensity of a Fe(200) plane satisfies the following formula (1).

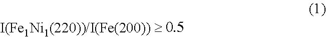

In the surface treated steel foil described in (1) above, (2) it is preferable that the ratio of the maximum value of diffraction intensity of a (211) plane of Fe, among crystal planes of Fe contained in the iron-nickel alloy layer, and the maximum value of diffraction intensity of the Fe(200) plane satisfy the following formula (2).

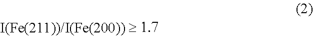

In addition, in the surface treated steel foil described in (1) or (2) above, (3) it is preferable that iron-nickel alloy layers be provided on both the first surface side and the second surface side of the base material, that Fe₁Ni₁ be contained as an alloy phase in the iron-nickel alloy layer on at least one surface side of the first surface side and the second surface side, that the orientation index in X-ray diffraction of the (220) plane of Fe₁Ni₁ in the surface having the iron-nickel alloy layer containing Fe₁Ni₁ be not less than 1.0, and that the ratio of the maximum value of diffraction intensity of the (220) plane of Fe₁Ni₁ and the maximum value of diffraction intensity of the Fe(200) plane satisfy the following formula (1).

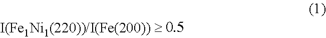

In the surface treated steel foil described in (3) above, (4) it is preferable that the following formula (3) be satisfied in the surface having the iron-nickel alloy layer containing Fe₁Ni₁.

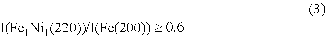

In the surface treated steel foil described in any one of (1) to (4) above, (5) it is preferable that the thickness of the surface treated steel foil as a whole be not more than 200 μm.

In the surface treated steel foil described in any one of (1) to (5) above, (6) it is preferable that the deposition amount of nickel in the iron-nickel alloy layers be 2.22 to 26.7 g/m² per one surface side.

In the surface treated steel foil described in any one of (1) to (6) above, (7) it is preferable that the surface treated steel foil further include a metallic layer formed on the iron-nickel alloy layer, the metallic layer being a nickel layer.

In the surface treated steel foil described in (7) above, (8) it is preferable that the total of nickel deposition amounts in the iron-nickel alloy layer and the nickel layer be 2.22 to 53.4 g/m².

In the surface treated steel foil described in any one of (1) to (8) above, (9) it is preferable that a hydrogen permeation current density measured electrochemically be not more than 55 μA/cm², where the hydrogen permeation current density is an increment of an oxidation current measured on a hydrogen detection side when a potential of −1.5 V is applied on a hydrogen generation side under a condition where a potential on the hydrogen detection side is +0.4 V in a liquid electrolyte at 65° C. with a reference electrode for potentials on the hydrogen detection side and the hydrogen generation side being Ag/AgCl.

In the surface treated steel foil described in any one of (1) to (9) above, (10) it is preferable that a roughened nickel layer be formed at an outermost surface on at least one of the first surface side and the second surface side, and that a three-dimensional surface property parameter Sa of the roughened nickel layer be 0.2 to 1.3 μm.

In the surface treated steel foil described in any one of (1) to (10) above, (11) it is preferable that the surface treated steel foil be for a current collector of a battery.

In the surface treated steel foil described in (11) above, (12) it is preferable that the surface treated steel foil be for a current collector of a bipolar battery.

In the surface treated steel foil described in (11) or (12) above, (13) it is preferable that a surface treated steel foil having a first surface on which a hydrogen occluding alloy is disposed and a second surface located on a side opposite to the first surface include a base material composed of a low carbon steel or an ultra low carbon steel and an iron-nickel alloy layer that is laminated on the base material on at least one surface side of the first surface side and the second surface side and that restrains permeation or diffusion of hydrogen in the surface treated steel foil, in which Fe₁Ni₁ is contained as an alloy phase in the iron-nickel alloy layer, an orientation index in X-ray diffraction of a (220) plane of Fe₁Ni₁ in the surface having the iron-nickel alloy layer is not less than 1.0, and the ratio of the maximum value of diffraction intensity of the (220) plane of Fe₁Ni₁ and the maximum value of diffraction intensity of a Fe(200) plane satisfies the following formula (1).

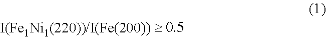

### Advantageous Effects of Invention

According to the present invention, it is possible to provide a surface treated steel foil that has hydrogen barrier properties.

### BRIEF DESCRIPTION OF DRAWING

FIG. 1(a) is a diagram schematically depicting a surface treated steel foil of the present embodiment.

FIG. 1(b) is a diagram schematically depicting the surface treated steel foil of the present embodiment.

FIG. 1(c) is a diagram schematically depicting the surface treated steel foil of the present embodiment.

FIG. 2(a) is a schematic diagram of a device for measuring hydrogen barrier properties of a surface treated steel foil 10 of the present embodiment.

FIG. 2(b) is a schematic diagram of the device for measuring hydrogen barrier properties of the surface treated steel foil 10 of the present embodiment.

FIG. 2(c) is an explanation diagram of a method for measuring hydrogen barrier properties of the surface treated steel foil 10 of the present embodiment.

FIG. 2(d) is an explanation diagram of the method for measuring hydrogen barrier properties of the surface treated steel foil 10 of the present embodiment.

FIG. 2(e) is an explanation diagram of the method for measuring hydrogen battier properties of the surface treated steel foil 10 of the present embodiment.

FIG. 3 is a diagram for explaining a method for calculating the thickness of an iron-nickel alloy layer in the present embodiment.

FIG. 4 is a diagram for explaining a method for calculating the thickness of an iron-nickel alloy layer by use of glow discharge optical emission spectroscopy (GDS) in the present embodiment.

FIG. 5 is a diagram schematically depicting a surface treated steel foil in another embodiment.

FIG. 6(a) is a diagram schematically depicting a surface treated steel foil of another embodiment.

FIG. 6(b) is a diagram schematically depicting a surface treated steel foil of another embodiment.

FIG. 7 is a diagram schematically depicting a surface treated steel foil of another embodiment.

FIG. 8(a) is a diagram depicting a manufacturing method for a surface treated steel foil in the present embodiment.

FIG. 8(b) is a diagram depicting a manufacturing method for a surface treated steel foil in the present embodiment.

### DESCRIPTION OF EMBODIMENT

### <<Surface Treated Steel Foil 10>>

An embodiment for implementing a surface treated steel foil of the present invention will be described below.

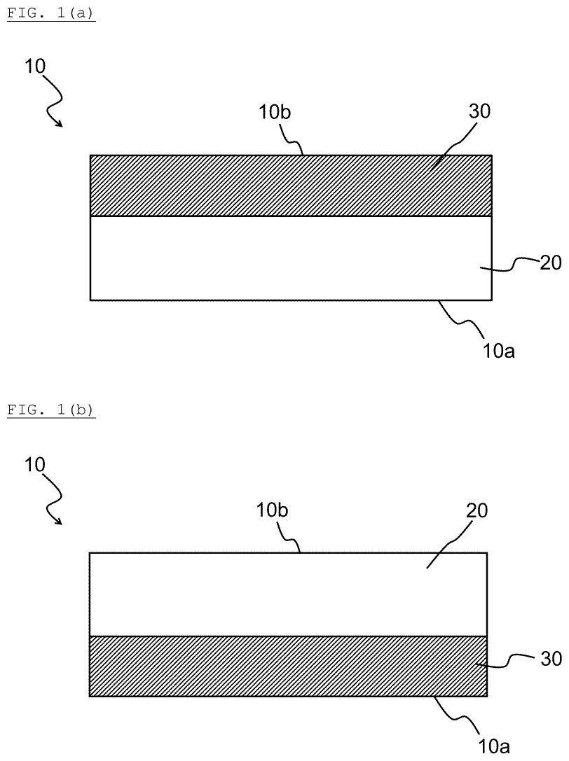

FIG. 1 is a diagram schematically depicting an embodiment of a surface treated steel foil 10 of the present invention. The surface treated steel foil 10 of the present embodiment may be applied not only to a current collector of a bipolar battery but also to a current collector for a positive electrode or a negative electrode in a monopolar battery. The battery may be a secondary battery or a primary battery.

The surface treated steel foil 10 of the present embodiment has a base material 20 and an iron-nickel alloy layer 30. The surface treated steel foil 10 has a first surface 10a and a second surface 10b on the side opposite to the first surface 10a. In the case where the surface treated steel foil 10 of the present embodiment is used as a battery current collector of a battery including a hydrogen occluding alloy, on the side of the first surface 10a, there is disposed a hydrogen occluding alloy as a negative electrode material in assembling a battery. Meanwhile, on the side of the second surface 10b, there is disposed a positive electrode material in the case of a nickel-hydrogen battery of a bipolar electrode structure, for example.

The surface treated steel foil 10 of the present embodiment is characterized by having the iron-nickel alloy layer 30 as described above. The iron-nickel alloy layer 30 may be disposed on the side of the above-mentioned second surface 10b as depicted in FIG. 1(a), or may be disposed on the side of the first surface 10a as depicted in FIG. 1(b). In addition, the iron-nickel alloy layer 30 may be disposed on both the side of the first surface 10a and the side of the second surface 10b as depicted in FIG. 1(c).

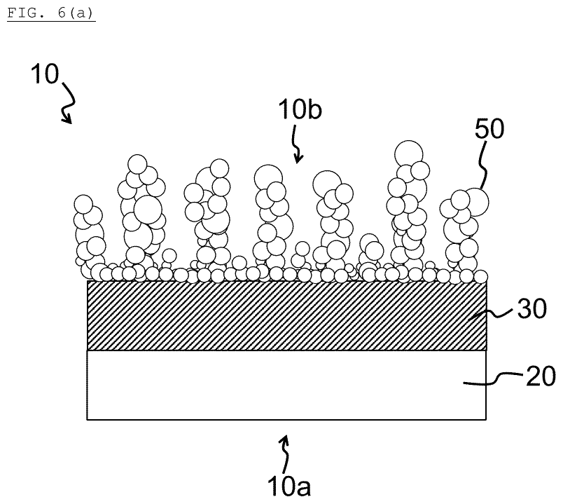

In addition, the iron-nickel alloy layer 30 may be disposed at an outermost surface of the surface treated steel foil 10 as depicted in FIGS. 1(a) to 1(c), or may be disposed inside (at an intermediate position) of the surface treated steel foil 10 as depicted in FIG. 5.

The iron-nickel alloy layer 30 has a function of restraining permeation or diffusion of hydrogen in the surface treated steel foil for a current collector.

### <Base Material 20>

As the kind of a steel foil of the base material 20 used for the surface treated steel foil 10 of the present embodiment, specifically, a low carbon steel (carbon content 0.01 to 0.15 wt %) represented by a low carbon aluminum-killed steel, an ultra low carbon steel having a carbon content of less than 0.01 wt %, or a non-ageing ultra low carbon steel obtained by adding Ti, Nb, or the like to an ultra low carbon steel is preferably used.

The thickness of the base material 20 used for the surface treated steel foil 10 of the present embodiment is preferably in the range of 10 to 200 μm. In the case of use as a current collector of a battery in which a volume and weight energy density is considered to be important, the thickness is more preferably 25 to 100 μm, and further preferably 10 to 80 μm, in terms of strength, desired battery capacity, and the like. For measurement of the thickness of the base material 20, thickness measurement by observation of a section by an optical microscope or a scanning electron microscope (SEM) is applicable.

### <Iron-Nickel Alloy Layer 30>

The iron-nickel alloy layer 30 included in the surface treated steel foil 10 of the present embodiment is an alloy layer containing iron (Fe) and nickel (Ni) and is an alloy layer including an alloy composed of iron and nickel (also called an “iron-nickel alloy” or an “Fe—Ni alloy”). Note that the state of the alloy composed of iron and nickel may be any of a solid solution, a eutectoid or eutectic, and a compound (intermetallic compound) or may include them in a coexistent state.

The iron-nickel alloy layer 30 included in the surface treated steel foil 10 of the present embodiment may contain other metallic elements and unavoidable impurities insofar as the problem to be solved by the present invention can be solved. For example, the iron-nickel alloy layer 30 may contain metallic elements such cobalt (Co) and molybdenum (Mo) and additive elements such as boron (B). Note that the proportion of metallic elements other than iron (Fe) and nickel (Ni) in the iron-nickel alloy layer 30 is preferably not more than 10 wt %, more preferably not more than 5 wt %, and further preferably not more than 1 wt %. Since the iron-nickel alloy layer 30 may be a binary alloy substantially composed of only iron and nickel, the lower limit for the content of metallic elements other than unavoidable impurities is 0 wt %.

The kinds and amounts of the other metallic elements contained can be measured by known means such as an X-ray fluorescence (XRF) measuring device and GDS.

The iron-nickel alloy layer 30 included in the surface treated steel foil 10 in the present embodiment is formed by the following steps. A step of forming a nickel plating layer on a raw sheet to be a base material to obtain a nickel-plated material (nickel plating step), a step of subjecting the nickel-plated material to a heat treatment (first heat treatment step), a step of rolling the nickel-plated material after the heat treatment (first rolling step), and a step of performing a second heat treatment (second heat treatment step) are sequentially conducted in this order.

Note that the rolling in the above-mentioned “first rolling step” is also called “re-rolling” for implication of discrimination from rolling of the raw sheet to be the base material (cold rolling from a hot coil).

In addition, the heat treatment in the above-mentioned “second heat treatment step” is also referred to simply as a “second heat treatment.”

After the second heat treatment, a step (second rolling step) of performing rolling in such an extent as not to fall outside a configuration range of a formula (1) which will be described later may be performed.

Examples of nickel plating include electroplating, electroless plating, hot dip coating, and dry plating. Among these plating processes, the electroplating method is particularly preferred in terms of cost, film thickness control, and the like.

The details of the manufacturing method for the surface treated steel foil in the present embodiment will be described later.

The surface treated steel foil 10 in the present embodiment is characterized in that (a) Fe₁Ni₁ is contained as an alloy phase in the iron-nickel alloy layer 30, (b) an orientation index in X-ray diffraction of a (220) plane of Fe₁Ni₁ in the surface having the iron-nickel alloy layer 30 is not less than 1.0, and (c) the ratio of the maximum value of diffraction intensity of the (220) plane of Fe₁Ni₁ and the maximum value of diffraction intensity of a Fe(200) plane satisfies the following formula (1).

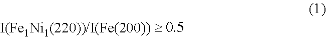

The characteristics (a), (b), and (c) described above will be described below.

As the first characteristic, the nickel plating, the first heat treatment, and the re-rolling steps in the above-mentioned manufacturing steps are conducted, whereby it is ensured that the iron-nickel alloy layer 30 formed in the second heat treatment performed thereafter will be in a state in which specifically oriented crystals are present in a large amount, as compared to the case where the alloy layer is formed by only the nickel plating and the heat treatment. Specifically, when X-ray diffraction is performed, the orientation index of the (220) plane is high. (The above-mentioned characteristic (b))

As the second characteristic, the surface treated steel foil having the iron-nickel alloy layer 30 in which the orientation index of the (220) plane is thus high is further characterized in that an alloy phase of the crystal structure of Fe₁Ni₁ is included in the iron-nickel alloy layer 30. (The above-mentioned characteristic (a))

The third characteristic is that the (220) plane of Fe₁Ni₁ is present in a sufficient amount in relation to the (200) plane of Fe, though the details will be described later. With this configuration, it is possible to achieve the hydrogen barrier properties suitable for bipolar batteries, that is, the problem of the present invention. (The above-mentioned characteristic (c)) Here, the reason why it is defined in the present embodiment that the alloy phase of the crystal structure of Fe₁Ni₁ is included in the iron-nickel alloy layer 30 is as follows.

In the process of repeating experiments for enhancing battery performance, the present inventors have found out that a voltage drop (self-discharge) phenomenon is generated by an unknown cause and that, for dissolving the phenomenon, it is effective to restrain permeation of hydrogen in the surface treated steel foil 10.

While the cause of generation of the hydrogen permeation and the reason why the generation of the above-mentioned voltage drop (self-discharge) phenomenon can be restrained by restraining the hydrogen permeation in the surface treated steel foil 10 have not yet been elucidated, the present inventors have estimated as follows.

In other words, in the present embodiment, in the case where the surface treated steel foil 10 is used for electrodes of a bipolar battery, a hydrogen occluding alloy to be used as a negative electrode material is disposed on at least one surface side (in the embodiment depicted in FIG. 1, the side of the first surface 10a) of the surface treated steel foil 10, and a positive electrode material is disposed on the opposite side. In this case, an environment (negative electrode) in which hydrogen is abundant and an environment (positive electrode) in which there is little hydrogen are present with the surface treated steel foil 10 therebetween, and there is generated a hydrogen concentration gradient. The present inventors have expected that some chance causes hydrogen to permeate and move in the surface treated steel foil 10, and the permeated hydrogen reacts on the positive electrode, whereby the above-mentioned voltage drop (self-discharge) is generated.

Then, the present inventors obtained various surface treated steel foils having the iron-nickel alloy layers 30, by modifying plating conditions, rolling conditions, heat treatment conditions, and the like. Further, they measured a hydrogen permeation current density (oxidation current value) in each of the steel foils, and analyzed the contents of metallic elements, the structures of alloys, and the like.

During the process in which the present inventors made extensive and intensive investigations and repeated experiments, they found out that, when an alloy phase of the crystal structure of Fe₁Ni₁ is present in an amount not less than a certain amount, it is possible to obtain a surface treated steel foil having hydrogen barrier properties with high stability, and it is possible to solve the problem of the above-mentioned hydrogen permeability. As a reason why the alloy phase of Fe₁Ni₁ of crystal structures of the iron-nickel alloy contributes largely to hydrogen barrier properties, it is considered that the structure of this alloy phase is low in porosity and hydrogen passages are narrow, and it is considered that the alloy contains in high density the lattice strain attendant on the difference in atomic radius between Fe and Ni, and hence, many hydrogen trap sites are present in the alloy; as a result, it is considered that, when this alloy phase is contained in a large amount in the iron-nickel alloy layer 30, the hydrogen barrier properties of the surface treated steel foil are remarkably enhanced.

Furthermore, the present inventors paid further attention to the crystal structure of Fe₁Ni₁, and by introducing orientation also in the Fe₁Ni₁(220) plane, as compared to a state in which the Fe₁Ni₁(200) plane is predominant and which is obtained through nickel plating and a heat treatment, they expected that the hydrogen passages are more complicated and the hydrogen barrier properties are more enhanced, and they tried to subject the iron-nickel alloy layer to rolling in order to introduce orientation in the Fe₁Ni₁(220) plane.

Meanwhile, it was found that, in the case where nickel plating, heat treatment, and re-rolling steps are performed in this order, the hydrogen barrier properties which should be obtained by the formation of Fe₁Ni₁ may be lowered. As a result of the present inventors' extensive and intensive investigations, the followings were found. First, upon research of the cause of the lowering in hydrogen barrier properties, it was found that, in the case where hydrogen barrier properties are obtained by an iron-nickel diffusion layer formed by a heat treatment after nickel plating, the hydrogen barrier properties are lowered when there is a large amount of iron which is exposed due to cracking of the iron-nickel diffusion layer at the time of re-rolling, or iron which is exposed in such a state as to break through the iron-nickel diffusion layer. Note that, since such a lowering in hydrogen barrier properties cannot be generated if only there is present the iron which is formed by the heat treatment and diffused to be detected at the surface, without undergoing re-rolling, it is considered that the lowering in the hydrogen barrier properties is generated when the re-rolling step is conducted. Upon repeated experiments with attention paid to this point, the lowering in hydrogen barrier properties is liable to occur particularly in the case where the draft in re-rolling is high, though depending on the state before the re-rolling, that is, on the configurations of soft nickel and the iron-nickel diffusion layer formed by the nickel plating and the heat treatment. In addition, it was found that the hydrogen barrier properties are lowered also when the formation of the Fe₁Ni₁ alloy phase upon the heat treatment and the second heat treatment is insufficient, even if exposure of iron is restrained to a certain extent, and that favorable hydrogen barrier properties can be obtained even when iron is exposed, if the exposure of iron is such an extent that the exposed iron can sufficiently alloy with the surrounding FeNi upon the second heat treatment. It was found out that, even in the surface treated steel foil obtained through nickel plating, a heat treatment, and re-rolling, it is important for obtaining more favorable hydrogen barrier properties to suppress the draft in re-rolling to thereby control the orientation of iron, and to configure a sufficient Fe₁Ni₁ alloy phase according to the draft.

Here, the presence of Fe₁Ni₁ included in the iron-nickel alloy layer 30 can be confirmed by use of X-ray diffraction (XRD) measurement. Specifically, in the case where diffraction intensity is obtained at a diffraction angle 2θ=75.1°±0.11° in X-ray diffraction measurement, the presence of a crystal plane (220) in the crystal structure of Fe₁Ni₁ included in the iron-nickel alloy layer 30 can be confirmed, and it can be said that the iron-nickel alloy layer 30 includes an alloy phase of the crystal structure of Fe₁Ni₁.

Further, the present embodiment is characterized in that the orientation index in X-ray diffraction of the Fe₁Ni₁(220) plane of crystal planes of Fe₁Ni₁ included in the iron-nickel alloy layer 30 is not less than 1.0, and further, the ratio of the maximum value of diffraction intensity of the Fe₁Ni₁(220) plane and the maximum value of diffraction intensity of the Fe(200) plane in X-ray diffraction satisfies the following formula.

$$I ( {Fe}_{1} {Ni}_{1} ( 220 ) ) / I ( Fe ( 200 ) ) \geq 0.5 \qquad ( 1 )$$

Here, “diffraction intensity is obtained at a diffraction angle 2θ=75.1°±0.11” is defined as “the maximum value of diffraction intensity at a diffraction angle 2θ=75.1°±0.11° is not less than 2.0 times the average value of diffraction intensity at a diffraction angle 2θ=860 0.5°.” In other words, the diffraction intensity at the diffraction angle 2θ=86°±0.5° in a sample obtained by forming nickel plating on a steel sheet is not influenced by iron nor nickel. Hence, in the case where a diffraction intensity of not less than 2.0 times the average value of diffraction intensity at the diffraction angle 2θ=86°±0.5° is obtained at the diffraction angle 2θ=75.1°±0.110 in X-ray diffraction measurement, it can be understood that the crystal plane (220) of the crystal structure of Fe₁Ni₁ included in the iron-nickel alloy layer 30 is present.

In the case where the above-mentioned formula (1) is satisfied, the lowering in the hydrogen barrier properties attendant on the exposure of iron which is generated at the time of the above-mentioned re-rolling step can be restrained, which is favorable. In addition, as a result, when the surface treated steel foil 10 is used as a current collector of a bipolar battery, it is possible to obtain excellent hydrogen barrier properties. From a viewpoint of hydrogen barrier properties, it is more preferable that the ratio expressed by the above formula (1) be not less than 0.6 on at least one surface side of the surface treated steel foil. In other words, it is preferable that the following formula (3) be satisfied.

$$I ( {Fe}_{1} {Ni}_{1} ( 220 ) ) / I ( Fe ( 200 ) ) \geq 0.6 \qquad ( 3 )$$

It is further preferable that the ratio expressed by the above formula (1) be not less than 0.8 on at least one surface side of the surface treated steel foil.

In addition, from a viewpoint of more stable hydrogen barrier properties, it is preferable that the surface treated steel foil in the present embodiment have the iron-nickel alloy layers 30 on both the first surface side and the second surface side, and it is sufficient if the formula (1) is satisfied on at least one surface side in a state in which the iron-nickel alloy layers 30 are provided on both surface sides, but further, it is preferable that the formula (3) be satisfied on at least one surface side. There is no upper limit for the ratio expressed by the above formula (1) or (3), but taking into account the thickness of iron in the iron-nickel alloy layer and the base material and intensity balance, it is preferable that the ratio be less than 10. With the ratio being less than 10, it is possible to control mechanical properties of the current collector surface treated steel foil by control of the state of iron in the base material, and the control is easy to perform. On the other hand, in a state in which the above-mentioned ratio is not less than 10, the iron-nickel alloy layer harder than iron in the base material is formed thick, and it is considered that the mechanical properties of the current collector surface treated steel foil are liable to be influenced by the iron-nickel alloy layer.

Note that “I(Fe₁Ni₁(220))” in the above formula (1) or (3) means the maximum value of diffraction intensity obtained at a diffraction angle 2θ=75.1°±0.11° in the above-mentioned X-ray diffraction measurement. The diffraction intensity obtained at the above-mentioned diffraction angle indicates the (220) plane of Fe₁Ni₁. (This is based on 01-071-8322 of the data base of ICDD PDF-2 2014.)

In addition, “I(Fe(200))” means the maximum value of diffraction intensity obtained at a diffraction angle 2θ=65.02°±0.11° in the X-ray diffraction measurement. The diffraction intensity obtained at the above-mentioned diffraction angle indicates the (200) plane of iron (Fe). (This is based on 01-071-3763 of the data base of ICDD PDF-2 2014.)

The reason why the ratio of the diffraction intensity of the (220) plane of Fe₁Ni₁ and the diffraction intensity of the (200) plane of iron (Fe) is regarded as an index of hydrogen barrier properties of Fe₁Ni₁ in the present application is as follows. Specifically, as a result of the present inventors' extensive and intensive investigations while repeating experiments, it was found out that, with attention being paid to the fact that the diffraction intensity arising from the (200) plane of iron is influenced by the rolling conditions for re-rolling and the second heat treatment conditions, in the case where the surface treated steel foil having the iron-nickel alloy layer is obtained through the steps of the above-mentioned nickel plating, the first heat treatment, the re-rolling, and the second heat treatment, by indexing the diffraction intensity by the above formula, the indexed value is a numerical value associated with the result of hydrogen barrier properties.

It has been confirmed that the matrix of an original rolling texture of iron is the Fe(211) plane and that, with respect to test samples, also, the Fe(211) plane is higher as an orientation index. However, with respect to the diffraction intensity of the Fe (211) plane, an index associated with hydrogen barrier properties was not found. This is probably because the diffraction intensity of the Fe(211) plane is more influenced by an increase in diffraction intensity due to recovery from processing of iron itself, that is, the carbon steel base material itself, rather than being decreased due to alloying of iron and nickel.

In view of this, the present inventors used Fe (200) for the ratio with the (220) plane of Fe₁Ni₁ of the iron-nickel alloy phase as an index for observing the degree of exposure of iron.

It is considered that, in the case where the left side of the above formula (1) is too small, the draft in the re-rolling is too high, or heat treatment in the second heat treatment is insufficient, thereby resulting in that the residual part of the above-mentioned exposure of iron is much and the hydrogen barrier properties would be lowered.

It is considered that, when the left side is not less than 0.5, or, in other words, by controlling the draft in the re-rolling and performing a sufficient heat treatment in the second heat treatment, like in the present embodiment, the exposure of iron itself is restrained, or even if iron is partly exposed, iron in the vicinity of the surface is alloyed with the surrounding iron-nickel alloy layer at the time of the second heat treatment, whereby the lowering in hydrogen barrier properties can be restrained.

Note that it is considered that, when the draft in the re-rolling is too high, even if the second heat treatment is sufficiently conducted, the exposure of iron cannot be sufficiently suppressed, and the hydrogen barrier properties would be lowered.

Note that, in the case where the surface treated steel foil is manufactured by the above-mentioned manufacturing steps, the orientation obtained is characterized in that the orientation index in X-ray diffraction of the (220) plane of Fe₁Ni₁ is not less than 1.0, and hence, the (220) plane of Fe₁Ni₁ was used as an index for observing the degree of exposure of iron. Particularly when the surface treated steel foil is rolled to a thin form of below 100 μm and the final thickness of the surface treated steel foil is made less than 100 μm, a strong orientation of not less than 2.0 is exhibited.

Note that an upper limit for the orientation index is not particularly limited to any value and is normally less than 6.0.

The crystal orientation index Ico_Fe₁Ni₁(220) in X-ray diffraction of the (220) plane of Fe₁Ni₁ was defined and calculated by the following formula. The suffix co means crystal orientation.

$$\\ {Ico\_Fe}_{1} {Ni}_{1} ( 220 ) = [ {I\_Fe}_{1} {Ni}_{1} ( 220 ) / [ \begin{matrix}{I\_Fe}_{1} {Ni}_{1} ( 111 ) + {I\_Fe}_{1} {Ni}_{1} ( 200 ) + \\ {I\_Fe}_{1} {Ni}_{1} ( 220 ) + {I\_Fe}_{1} {Ni}_{1} ( 311 ) + {I\_Fe}_{1} {Ni}_{1} ( 222 )\end{matrix} ] ] / [ {I}_{s} {\_Fe}_{1} {Ni}_{1} ( 220 ) / [ \begin{matrix}{I}_{s} {\_Fe}_{1} {Ni}_{1} ( 111 ) + {I}_{s} {\_Fe}_{1} {Ni}_{1} ( 200 ) + \\ {I}_{s} {\_Fe}_{1} {Ni}_{1} ( 220 ) + {I}_{s} {\_Fe}_{1} {Ni}_{1} ( 311 ) + {I}_{s} {\_Fe}_{1} {Ni}_{1} ( 222 )\end{matrix} ] ]$$

Here, the diffraction intensities of crystal planes of Fe₁Ni₁ measured by X-ray diffraction are expressed as follows.
I_Fe₁Ni₁(111): diffraction intensity of the Fe₁Ni₁(111) crystal plane measured by X-ray diffraction
I_Fe₁Ni₁ (200): diffraction intensity of the Fe₁Ni₁(200) crystal plane measured by X-ray diffraction
I_Fe₁Ni₁(220): diffraction intensity of the Fe₁Ni₁(220) crystal plane measured by X-ray diffraction
I_Fe₁Ni₁(311): diffraction intensity of the Fe₁Ni₁(311) crystal plane measured by X-ray diffraction
I_Fe₁Ni₁(222): diffraction intensity of the Fe₁Ni₁(222) crystal plane measured by X-ray diffraction

The diffraction intensity here is the maximum value of diffraction intensity (cps) measured in the range of each diffraction angle (2θ)±0.110 described in Joint Committee on Powder Diffraction Standards (JCPDS, PDF card No.: 01-071-8322).

Specifically, the (111) plane is the maximum value in the range of 43.83°±0.11°, the (200) plane is that in the range of 51.05°±0.11°, the (220) plane is that in the range of 75.10°±0.11°, the (311) plane is that in the range of 91.23°±0.11°, and the (222) plane is that in the range of 96.56°±0.11°.

Next, as standard diffraction peak intensity values in crystal planes of Fe₁Ni₁(Iₛ_Fe₁Ni₁(111), Iₛ_Fe₁Ni₁(200), Iₛ_Fe₁Ni₁ (220), Iₛ_Fe₁Ni₁ (311), and Iₛ_Fe₁Ni₁ (222)), those values as described in JCPDS (PDF card No.: 01-071-8322) can be used. The suffix s means Standard.

In addition, in order to enhance hydrogen barrier properties by realizing a crystal structure not predominantly oriented only in the Fe₁Ni₁(200) plane but oriented also in the Fe₁Ni₁(220) plane, the ratio of the orientation index of the (220) and the crystal orientation index of the Fe₁Ni₁(200) plane calculated similarly to the above, that is, the ratio Ico_Fe₁Ni₁(220)/Ico_Fe₁Ni₁(200) is preferably from 1.0 to 5.0, more preferably from 1.0 to 4.0, and further preferably from 1.5 to 3.5. Note that, from a viewpoint of preventing excessive orientation in the (220) plane, Ico_Fe₁Ni₁(200) is preferably from 1.0 to 2.5, more preferably 1.0 to 2.0.

The crystal orientation index Ico_Fe₁Ni₁(200) in X-ray diffraction of the (200) plane of Fe₁Ni₁ is defined and calculated by the following formula. The suffix co means crystal orientation.

$$\\ {Ico\_Fe}_{1} {Ni}_{1} ( 200 ) = [ {I\_Fe}_{1} {Ni}_{1} ( 200 ) / [ \begin{matrix}{I\_Fe}_{1} {Ni}_{1} ( 111 ) + {I\_Fe}_{1} {Ni}_{1} ( 200 ) + \\ {I\_Fe}_{1} {Ni}_{1} ( 220 ) + {I\_Fe}_{1} {Ni}_{1} ( 311 ) + {I\_Fe}_{1} {Ni}_{1} ( 222 )\end{matrix} ] ] / [ {I}_{s} {\_Fe}_{1} {Ni}_{1} ( 200 ) / [ \begin{matrix}{I}_{s} {\_Fe}_{1} {Ni}_{1} ( 111 ) + {I}_{s} {\_Fe}_{1} {Ni}_{1} ( 200 ) + \\ {I}_{s} {\_Fe}_{1} {Ni}_{1} ( 220 ) + {I}_{s} {\_Fe}_{1} {Ni}_{1} ( 311 ) + {I}_{s} {\_Fe}_{1} {Ni}_{1} ( 222 )\end{matrix} ] ]$$

Note that, with respect to the surface treated steel foil obtained by not conducting the re-rolling or the second heat treatment step after the heat treatment is performed after the nickel plating, the orientation index of the (220) plane of Fe₁Ni₁ is on the order of from 0.35 to 0.85 in the case of performing the nickel plating by use of either the Watts bath or the sulfamate bath.

Further, in the surface treated steel foil 10 in the present embodiment, it is preferable that the ratio of the maximum value of diffraction intensity of the Fe(211) plane and the maximum value of diffraction intensity of the Fe(200) plane in X-ray diffraction satisfy the following formula (2).

$$I ( Fe ( 211 ) ) / I ( Fe ( 200 ) ) \geq 1.7 \qquad ( 2 )$$

The reason why the characteristic of the surface treated steel foil 10 in the present embodiment is expressed by the above formula (2) is as follows. Specifically, the iron crystal has a body-centered cubic (BCC) structure, the orientation which becomes predominant on rolling is the Fe{211} plane, and this orientation is hardly reduced even when subjected to the second heat treatment. On the other hand, the Fe{200} plane of iron is an orientation which is liable to be influenced by the rolling conditions of the re-rolling and the second heat treatment conditions as described above, and is specifically an orientation which is liable to occur upon rolling and which is liable to be reduced upon the second heat treatment. Hence, in the surface treated steel foil 10 in the present embodiment, the state of the steel foil in the case where the iron-nickel alloy layer 30 has undergone the rolling step satisfies the above formula (1) and the above formula (2), whereby it can be said that excessive rolling has not been carried out by the re-rolling, recovery has occurred upon the second heat treatment, and hydrogen barrier properties can be obtained stably. From the viewpoint of that the hydrogen barrier properties can be obtained more stably, it is preferable that “I(Fe(211)/I(Fe(200))≥2.0” be satisfied. While there is no particular upper limit for the ratio expressed by the above formula (2), the ratio is preferably less than 10 from a viewpoint of strength of the surface treated steel foil.

Note that “I(Fe(211))” in the above formula (2) means the maximum intensity obtained at a diffraction angle 2θ=82.33°±0.11° in X-ray diffraction measurement. The peak obtained at the above diffraction angle indicates the (211) plane of iron (Fe). (This is based on 01-071-3763 of the data base of ICDD PDF-2 2014.)

In the present embodiment, the iron-nickel alloy layer 30 may include alloy phases or the like of the crystal structure of Fe₁Ni₃ and/or Fe₃Ni₂ in addition to the alloy phase of the crystal structure of Fe₁Ni₁.

Note that the above-mentioned XRD measurement is carried out by an X-ray diffraction method using CuKα as a ray source, and the diffraction intensity is expressed in cps.

Note that, in the present embodiment, in order to restrain the generation of the voltage drop (self-discharge) as described above, with respect to the surface treated steel foil 10 in the present embodiment, the hydrogen permeation current density (oxidation current value) measured electrochemically is preferably not more than 55 μA/cm². Note that measuring conditions for the hydrogen permeation current density (oxidation current value) are a potential on the cathode side of −1.5 V and a potential on the anode side of +0.4 V, in a liquid electrolyte at 65° C.

Here, evaluation of hydrogen barrier properties will be described. In the case where hydrogen permeates and moves in the surface treated steel foil 10 as described above, hydrogen atoms reaching the hydrogen detection side from the hydrogen invasion side is oxidized, to become hydrogen ions. The value of an oxidation current in this instance varies according to the amount of hydrogen reaching a hydrogen detection surface, and hence, by the current value detected, the hydrogen barrier properties of the surface treated steel foil 10 can be digitized and evaluated (Tooru Tsuru, Tokyo Institute Of Technology, Zairyo-to-Kankyo (Materials and Environments), 63, 3-9(2014), Electrochemical Measurements for Hydrogen Entry and Permeation of Steel).

As a result of the above-mentioned expectation, the present inventors made measurement and evaluation, and in the present embodiment, have come to a conclusion that, in order to restrain the occurrence of the above-mentioned voltage drop (self-discharge) in a more stable manner, it is preferable that the surface treated steel foil 10 of the present embodiment have a hydrogen permeation current density, which is obtained from the oxidation current measured electrochemically, of not more than 55 μA/cm². Note that the measuring conditions for the hydrogen permeation current density in the present embodiment were a liquid electrolyte at 65° C., a reference electrode of silver/silver chloride (Ag/AgCl), a potential on the hydrogen generation side of −1.5 V, and a potential on the hydrogen detection side of +0.4 V. Note that all the numerical values of potential used in the measuring method for the hydrogen permeation current density in the present embodiment are based on the reference electrode of Ag/AgCl.

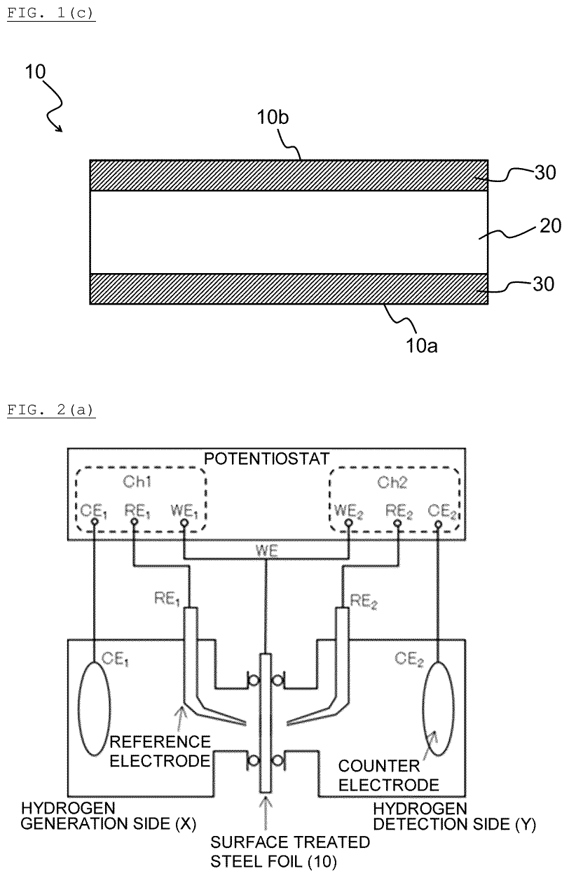

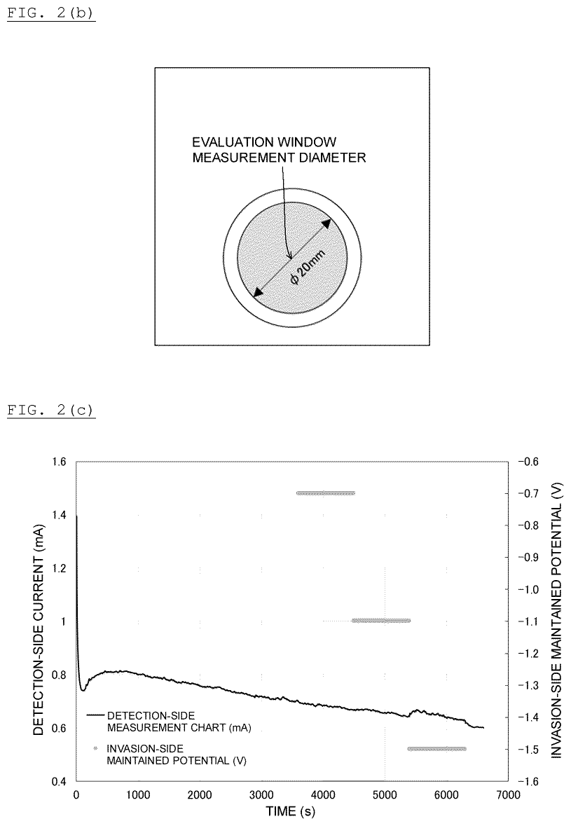

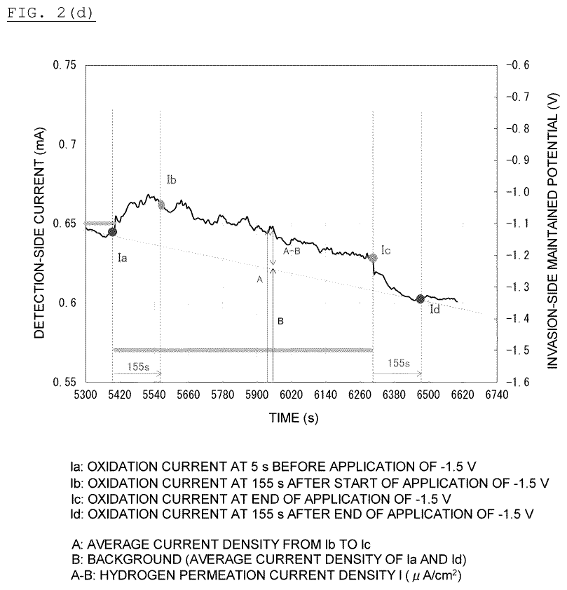

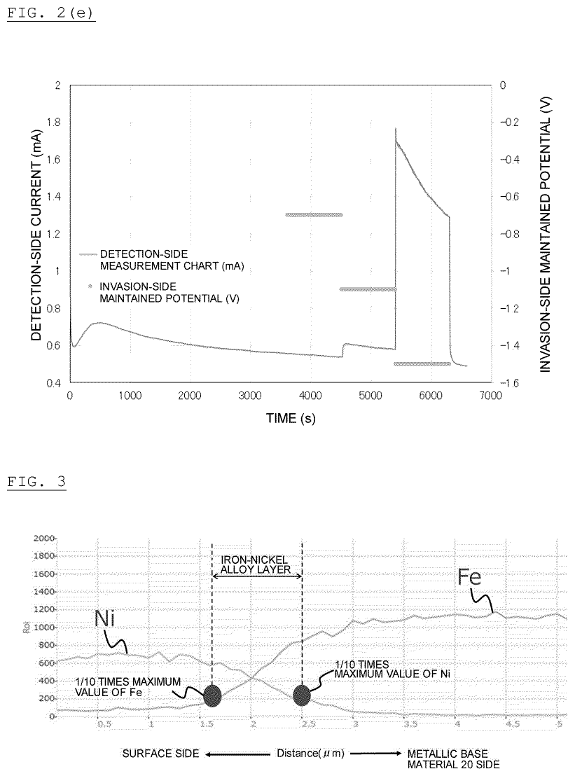

As a specific example of the measuring method for the hydrogen permeation current density in the present embodiment, a current value (current density) is detected by use of a measuring device configured as depicted in FIG. 2(a), so that the hydrogen barrier properties of the surface treated steel foil 10 can be digitized and evaluated. The measuring device depicted in FIG. 2(a) will be described below. In the following description, the hydrogen invasion side is referred to also as a hydrogen generation side, and is the side where a hydrogen occluding alloy is disposed, that is, the side of the first surface 10a of the surface treated steel foil 10. In addition, the hydrogen detection side is the side opposite to the hydrogen invasion side, and is the side of the positive electrode of a bipolar battery, that is, the side of the second surface 10b of the surface treated steel foil 10.

Two cells, i.e., a cell X for hydrogen generation and a cell Y for detection of permeated hydrogen, are prepared, and a test piece (sample) of the surface treated steel foil 10 is disposed between the two measuring cells. An alkaline aqueous solution (alkaline liquid electrolyte) is accommodated in each of the measuring cells, and reference electrodes (RE1 and RE2) and counter electrodes (CE1 and CE2) are immersed in the electrolyte. An Ag/AgCl electrode in a saturated KCl solution is used as the reference electrode, and platinum (Pt) is used as the counter electrode. In addition, the alkaline liquid electrolyte has a composition including KOH, NaOH, and LiOH, and its temperature is 65° C. Besides, as depicted in FIG. 2(b), the measured diameter of the surface treated steel foil 10 is φ20 mm (measured area: 3.14 cm²). Potential control and current measurement on the hydrogen invasion side and the hydrogen detection side are conducted by use of a potentiostat as depicted in FIG. 2(a). As the potentiostat, for example, a “multi-electrochemical measurement system HZ-Pro” made by HOKUTO DENKO CORPORATION can be used. Note that connection of the sample of the surface treated steel foil 10 to be evaluated and electrodes can be conducted as depicted in FIG. 2 (a).

The sample is polarized to a cathode (base potential) on the hydrogen generation side, hydrogen is generated on the surface of the sample, and hydrogen is caused to invade. The potential is applied stepwise at −0.7 V, −1.1 V, and −1.5 V, each potential being applied for 15 minutes. The reason why the potential is applied thus stepwise is to suppress an influence at the time of variation in the potential, and to obtain a stable plot. Note that measurement plots are obtained at intervals of five seconds.

Note that, in general, in a nickel-hydrogen battery using a nickel hydroxide compound as a positive electrode and a hydrogen occluding alloy as a negative electrode, an operating potential of the negative electrode in charge-discharge reactions of the battery is around −1.1 V. In the above-mentioned measuring method applicable to the present embodiment, as a technique by which it is possible to confirm the effect of the hydrogen barrier properties without using a hydrogen occluding alloy, measuring conditions for more conspicuous generation of hydrogen were investigated. Further, it was determined to use, for calculation of the hydrogen permeation current density I (μA/cm²), variation in oxidation current (hereinafter referred to also as the oxidation current variation) at the time when the applied potential on the hydrogen generation side is −1.5 V.

On the hydrogen detection side, when hydrogen atoms permeate from the hydrogen generation side to the hydrogen detection side, oxidation of the permeated hydrogen atoms on the hydrogen detection side results in generation of an oxidation current which is measured by the potentiostat on the hydrogen detection side. Hence, by this oxidation current variation, the hydrogen permeability of the surface treated steel foil 10 can be digitized and evaluated. Note that, on the hydrogen detection side, the potential applied is maintained in order to accelerate the oxidation of hydrogen atoms into hydrogen ions and to make clear the peak of the oxidation current.

In a nickel-hydrogen battery using a nickel hydroxide compound as the positive electrode and a hydrogen occluding alloy as the negative electrode, a positive electrode operating potential in charge-discharge reactions of the battery is generally around +0.4 V. In view of this, in the present measuring method, a potential of +0.4 V was applied on the detection side and was maintained during measurement. Note that, before applying the potential on the hydrogen generation side, the hydrogen detection side was maintained at the above-mentioned potential for 60 minutes for stabilization of current value. In addition, after the application of the potential on the hydrogen generation side is finished, that is, after the application of −1.5 V for 15 minutes is finished and the application on the hydrogen generation side becomes zero, application of +0.4 V on the hydrogen detection side is maintained for five minutes, for calculation of background. The measurement plots are at intervals of five seconds.

In other words, as a pre-step of evaluation by the measurement, first, an operation is started by applying +0.4 V on the hydrogen detection side, and next, the application is continued for 60 minutes to stabilize the current value, after which the application on the hydrogen generation side is started as practical evaluation (15 minutes at each potential, and a total of 45 minutes).

By the oxidation current variation on the hydrogen detection side obtained by the above-mentioned technique, the hydrogen permeation current density I (μA/cm²) can be calculated. A plot of the thus obtained oxidation current and a digitized image of the hydrogen permeation current density I (μA/cm²) are depicted in FIGS. 2(c) to 2(e).

FIG. 2(c) is a diagram depicting the current value measurement of a whole part inclusive of a pre-step and a post-step for evaluation. In addition, FIG. 2(d) is a diagram depicting variation in the current value for practical evaluation and is a diagram obtained by enlarging a part substantially ranging from 5,300 to 6,500 seconds in FIG. 2(c). FIG. 2(e) is a diagram for comparison of the present embodiment and is a diagram depicting variation in the current value in the case where current value measurement similar to that of FIG. 2(c) is conducted by use of a surface treated steel foil in which a nickel plating layer having a thickness of 1.0 μm is provided on a steel foil having a thickness of 50 μm and no heat treatment is conducted, that is, which is in a state not having an iron-nickel alloy layer. According to FIG. 2(e), it can be confirmed that, in the case of the surface treated steel foil not having the iron-nickel alloy layer constituting a characteristic feature of the present embodiment, the detection side current value during application of −1.5 V for 15 minutes is clearly high as compared to that in the case of the metallic foil depicted in FIG. 2(c).

Note that, in the present embodiment, the hydrogen permeation current density I (μA/cm²) can be calculated by the following formula, based on oxidation current variation at the time when the potential applied on the hydrogen generation side is −1.5 V as depicted in FIG. 2(d).

$$\\ Hydrogen permeation current density I ( µ A / {cm}^{2} ) = ( ( Average value of oxidation current from Ib to Ic ) / S ) - ( ( Average of Ia and Id ) / S )$$

where Ia (μA) is oxidation current at five seconds before application of −1.5 V, Ib (μA) is oxidation current at 155 seconds after the start of application of −1.5 V, Ic (μA) is oxidation current at the time when application of −1.5 V is finished, Id (μA) is oxidation current at 155 seconds after the finish of application of −1.5 V, and S (cm²) is the measurement area (evaluation area) of the measurement test piece.

It can be determined that, when the hydrogen permeation current density I (μA/cm²) calculated by the above formula is small, permeation of hydrogen is restrained, in other words, hydrogen barrier properties are high, whereas, when the hydrogen permeation current density I (μA/cm²) is large, permeation of hydrogen occurs easily.

In the present embodiment, it has been concluded that, in the case where the hydrogen permeation current density electrochemically measured as described above is not more than 55 μA/cm², such a hydrogen permeation current density is suitable for a bipolar electrode in terms of more stable hydrogen barrier properties inside the surface treated steel foil 10. The hydrogen permeation current density is more preferably not more than 30 μA/cm², further preferably not more than 20 μA/cm², and especially preferably not more than 15 μA/cm² in terms of restraining more of the voltage drop. It is to be noted that the hydrogen permeation current density is an increment of the oxidation current measured on the hydrogen detection side (anode side) when a potential of −1.5 V is applied on the hydrogen generation side (cathode side) under a condition where the potential on the hydrogen detection side is +0.4 V (vs Ag/AgCl) in a liquid electrolyte at 65° C. Note that, in the case where an increment of the oxidation current is not detected, the hydrogen permeation current density is 0 (zero).

Note that it is known that, in general, different metallic materials have different diffusion coefficients of hydrogen according to the respective kinds thereof, and in order to restrain defects and a hydrogen embrittlement phenomenon due to hydrogen in metal according to the use of the metallic material, a metallic material that restrains invasion of hydrogen may be demanded. Examples of such a case include an example in which a high alloy steel is used for restraining delayed fracture of a high strength bolt, and an example in which a titanium welded member is used for restraining cracking of a pressure reaction vessel.

However, such materials and uses are not based on the assumption of hydrogen invasion under an environment where the hydrogen amount is positively enhanced, such as placing a hydrogen occluding alloy on a surface. In addition, a problem in these technologies is an influence hydrogen remaining in the metal has on mechanical properties of the metal itself, and there is generated no problem regarding the influence of permeation of hydrogen through a metallic material on the other surface side.

In addition, as hydrogen permeation in a battery material, it is known that, for example, hydrogen impermeability is demanded as a gas impermeability in a separator of a fuel cell. It is to be noted, however, that, in fuel cells, it has been considered that hydrogen permeation is a problem mainly in the case of a carbon separator, whereas hydrogen permeation is not present and is not a problem in the cases where a stainless steel or aluminum separator is used. Besides, since corrosion resistance in a sulfuric acid atmosphere is indispensable to the separator of a fuel cell and application of a steel sheet is difficult, there has been found no problem based on an assumption that a steel sheet is applied. On the other hand, in a current collector in a bipolar electrode structure in which one surface of the current collector is made of a negative electrode active material layer and the other surface is made of a positive electrode active material layer, it has been verified that a hydrogen permeation phenomenon is generated easily as compared to the fuel cell and it may influence battery performance. This problem is considered to have been verified due to differences in battery structure, object part, internal environment, and the like from the fuel cell.

It is considered that the voltage drop caused by permeation of hydrogen as described above is accelerated in reaction thereof as there are a larger number of states in which hydrogen is liable to permeate under a battery use environment, and the time until the generation of the voltage drop is shorter, or, in other words, deterioration of battery performance is accelerated. As the condition for easier permeation of hydrogen, it is considered that hydrogen is more liable to permeate as the above-mentioned hydrogen concentration gradient is higher. It is also considered that, in addition to the hydrogen concentration gradient, a state in which voltages are applied on both surfaces of the surface treated steel foil causes hydrogen permeation to be further accelerated. In other words, in batteries using a hydrogen occluding alloy, in batteries in which the concentration gradient is high such as a nickel-hydrogen battery, and in secondary batteries charged and discharged frequently, it is possible that hydrogen permeation may be one of the causes of gradual lowering in battery performance with the lapse of time. On the other hand, other factors also largely contribute to the lowering in battery performance, and the phenomenon of hydrogen permeation is difficult to grasp, so that they have not been elucidated in conventional use and development of monopolar batteries; in this connection, during repeated experiments in the development of surface treated steel foils of bipolar batteries by the present inventors, they have arrived at a conclusion that enhancement of hydrogen barrier properties of the iron-nickel alloy layer contributes to restraining of deterioration of battery performance. Hence, the surface treated steel foil in the present embodiment is suitably used particularly for a current collector of a bipolar battery, particularly a battery using a hydrogen occluding alloy; however, even other batteries not using a hydrogen occluding alloy, if the batteries contain hydrogen or involve generation of hydrogen, it is considered that these batteries may suffer gradual deterioration of battery performance due to hydrogen permeation which has not been considered hitherto, so that the surface treated steel foil of the present embodiment can be suitably used for these batteries. For example, in alkaline secondary batteries, the battery constituting members are substantially the same, such as the use of an alkaline liquid electrolyte containing potassium hydroxide as a main constituent like that in a nickel-hydrogen battery, except that zinc is used for the negative electrode in a nickel-zinc battery and cadmium is used for the negative electrode in a nickel-cadmium battery, so that the alkaline secondary batteries are characterized in that hydrogen is liable to be generated on the negative electrode side.

Hence, when these batteries are regarded as bipolar batteries of the bipolar type structure, it is considered that a moving phenomenon of hydrogen may occur between the face and back of a current collector, and that battery performance is liable to be lowered similarly due to hydrogen permeation, though not to the extent in the case of a nickel-hydrogen battery in which a large amount of hydrogen is stored in a hydrogen occluding alloy. Therefore, the surface treated steel foil of the present embodiment can be suitably used also for bipolar type alkaline secondary batteries.

Further, from a viewpoint of restraining the hydrogen permeation as mentioned above, the thickness of the iron-nickel alloy layer 30 included in the surface treated steel foil 10 of the present embodiment is preferably not less than 1.0 μm, and more preferably not less than 1.6 μm.

Note that a method of calculating the thickness of the iron-nickel alloy layer 30 in the present embodiment will be described. As the calculating method for the thickness of the iron-nickel alloy layer 30 in the present embodiment, by an analysis using SEM-energy dispersive X-ray spectroscopy (EDX), a quantitative analysis of Ni and Fe at a depth of up to 10 μm in the thickness direction from the front surface can be performed.

An example of the method for obtaining the thickness of the iron-nickel alloy layer 30 from a graph obtained by SEM-EDX will be described. In a graph in FIG. 3, the axis of abscissas represents the distance (μm) in the depth direction from the front surface, and the axis of ordinates represents the X-ray intensity of Ni and Fe. It is indicated in the graph in FIG. 3 that, in a shallow part toward the thickness direction, nickel content is large and iron content is small. On the other hand, the iron content gradually increases in going forward in the thickness direction.

At parts in front of and behind an intersection of the curve of nickel and the curve of iron, in the present embodiment, the distance between 1/10 times the maximum value of nickel and 1/10 times the maximum value of iron is deemed as the thickness of the iron-nickel alloy layer 30, and the thickness can be read from the graph.

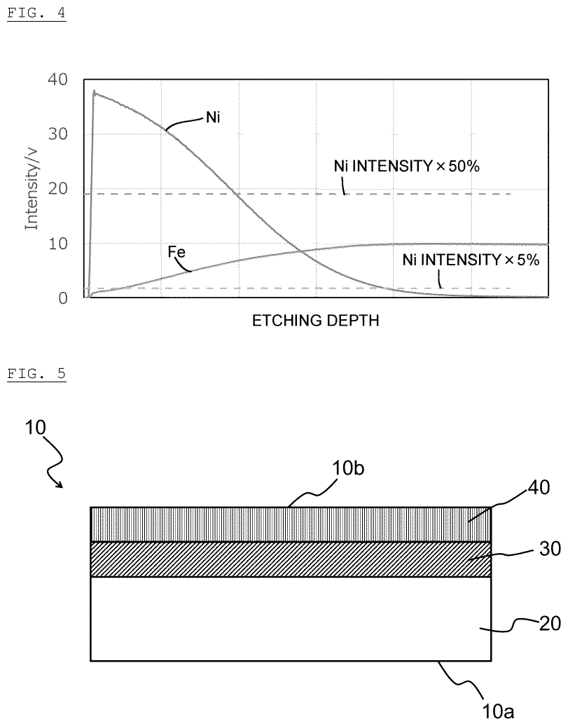

Note that, as a method for measuring the thickness of the iron-nickel alloy layer, there is known a method of measuring the thickness of the iron-nickel alloy layer by a technique based on the known GDS as depicted in FIG. 4, but in the present embodiment, since accurate measurement is impossible by the GDS in the case where a roughened nickel layer is provided on the iron-nickel alloy layer 30 as described later, a measuring method by the above-mentioned SEM-EDX is recommended. Note that, in the present embodiment, while, by the second heat treatment, alloying of the exposed part of iron at the surface can be promoted and the presence of a sufficient amount of Fe₁Ni₁ can be obtained, it was able to be confirmed that, as a result of this, the region where Ni is 5 to 50 mass % of the iron-nickel alloy layer measured by the GDS becomes conspicuously thick to such an extent as to exceed 80% based on the thickness of a region on the upper layer side of the region in a state after the second heat treatment step.

In addition, in the case where the thickness of the iron-nickel alloy layer is not less than 1.0 μm, it is a problem in the present application that, although a certain level of hydrogen barrier properties can be obtained, when steps including re-rolling are conducted, enhancement of the hydrogen barrier properties expected by an increase in the thickness of the iron-nickel alloy layer cannot be obtained. In other words, the iron partially exposed as described above is not uniformly present at the surface but is present locally; hence, even if the average value of the thickness of the iron-nickel alloy layer over the whole surface is not less than 1.0 μm, by only the thickness measured by GDS or EDS, control concerning the exposure of iron cannot be performed, and the problem of the present application cannot be expected nor solved.

In the surface treated steel foil 10 in the present embodiment, it is preferable, in terms of hydrogen barrier properties, liquid electrolyte resistance, and the like suitable for a bipolar electrode, that the deposition amount of nickel in the iron-nickel alloy layer 30 be 2.2 to 26.7 g/m².

In addition, in the surface treated steel foil 10 in the present embodiment, the iron-nickel alloy layer 30 may be formed on both surface sides of the base material 20 as depicted in FIG. 1(c), in which case the deposition amount of nickel in the iron-nickel alloy layers on both surface sides is preferably 4.4 to 53.4 g/m² in total.

The above-mentioned deposition amount of nickel can be determined by measuring the total nickel amount of the iron-nickel alloy layer 30 by an X-ray fluorescence device, but this method is not limitative, and other known measuring methods can also be used.

In the present embodiment, the iron-nickel alloy layer 30 may be a layer formed without addition of a brightening agent, or may be a layer formed by addition of a brightening agent (inclusive of a brightening agent for semi-luster).

Note that “lustrous” or “lusterless” in the above description depends on evaluation of visual appearance and it is difficult to rigorously classify them in terms of numerical values. Further, the degree of luster can vary according to other parameters such as bath temperature described later. Hence, the “lustrous” or the “lusterless” used in the present embodiment is just a definition in the case of paying attention to the presence or absence of a brightening agent.

Next, the thickness of the whole part of the surface treated steel foil 10 in the present embodiment will be described.

The thickness of the whole part of the surface treated steel foil 10 in the present embodiment, in the case where the steel foil does not have a roughened nickel layer 50 which will be described later, is preferably not more than 200 μm. In addition, in terms of strength, desired battery capacity, and the like, the thickness is more preferably 10 to 100 μm, further preferably 25 to 90 μm, and much further preferably 25 to 70 μm.

On the other hand, the thickness of the whole part of the surface treated steel foil 10 in the present embodiment, in the case where the steel foil has the roughened nickel layer 50 which will be described later at the outermost surface, is preferably not more than 210 μm. Besides, in terms of strength, desired battery capacity, and the like, the thickness is more preferably 20 to 110 μm, further preferably 35 to 100 μm, and much further preferably 35 to 80 μm.

In the case where the thickness exceeds the upper limit of the above-mentioned thickness range, the thickness is unfavorable in terms of a volume and weight energy density of the battery to be manufactured, and is unfavorable particularly in the case where thinning of the battery is intended. On the other hand, in the case where the thickness is less than the lower limit of the above-mentioned thickness range, not only does it become difficult to realize a strength sufficient against the influence of charging and discharging of the battery, but there is also a high possibility of generation of breakage, rupture, wrinkling, or the like during manufacture, handling, and the like of the battery.

Note that, for “the thickness of the surface treated steel foil 10” in the present embodiment, thickness measurement by use of a micrometer is preferable.

The surface treated steel foil 10 in the present embodiment may further have a metallic layer 40 formed on the above-mentioned iron-nickel alloy layer 30, as depicted in FIG. 5. Examples of the metallic material constituting the metallic layer 40 include nickel, chromium, titanium, copper, cobalt, iron, and the like. Of these kinds of metal, nickel and nickel alloys are particularly preferable for the reason of being excellent in corrosion resistance and strength.

In other words, in the surface treated steel foil 10 in the present embodiment, effects of formation of the metallic layer 40 on the iron-nickel alloy layer 30 are as follows. By forming the metallic layer 40 in addition to the iron-nickel alloy layer 30, conductivity, corrosion resistance, strength, and the like of the surface treated steel foil 10 as a whole can be adjusted, and the surface treated steel foil can be manufactured as a current collector material having desired properties.

In the case where the metallic layer 40 is a nickel layer in the surface treated steel foil 10 for a current collector in the present embodiment, it is preferable, in terms of hydrogen barrier properties, liquid electrolyte resistance, and the like, that the total of the nickel deposition amounts in the iron-nickel alloy layer 30 and the metallic layer 40 (nickel layer) be 3.0 to 53.4 g/m², more preferably 3.0 to 26.7 g/m². Note that the total nickel deposition amounts in the iron-nickel alloy layer 30 and the metallic layer 40 can be measured by X-ray fluorescence analysis (XRF) or the like.

Note that the thickness of the metallic layer 40 is preferably 0.1 to 8.0 μm. In addition, as for the thickness ratio of the iron-nickel alloy layer 30 and the metallic layer 40 in the surface treated steel foil 10, particularly in the case where the metallic layer 40 is a nickel layer, it is preferable, in terms of enhancing the liquid electrolyte resistance while more enhancing the hydrogen barrier properties, that the iron-nickel alloy layer 30: the metallic layer 40=3:10 to 60:1, and more preferably the iron-nickel alloy layer 30: the metallic layer 40=3:4 to 35:1.

As for a measuring method for the thickness of the metallic layer 40, also, as in the case of the iron-nickel alloy layer 30, thickness measurement by SEM-EDX of a section of the surface treated steel foil is applicable.

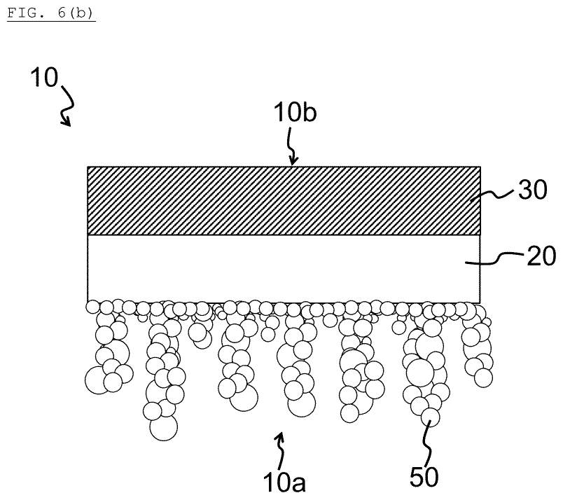

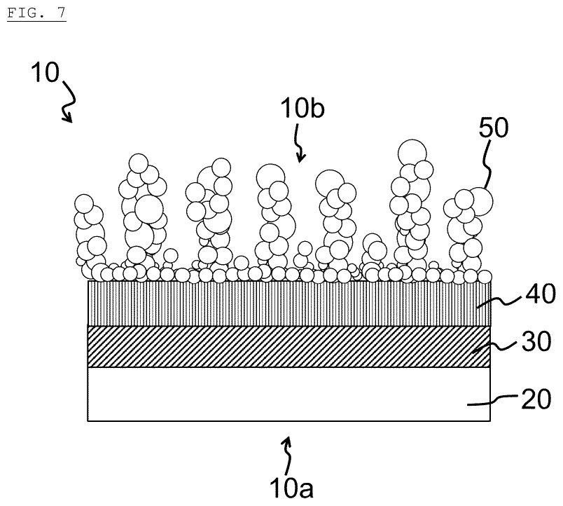

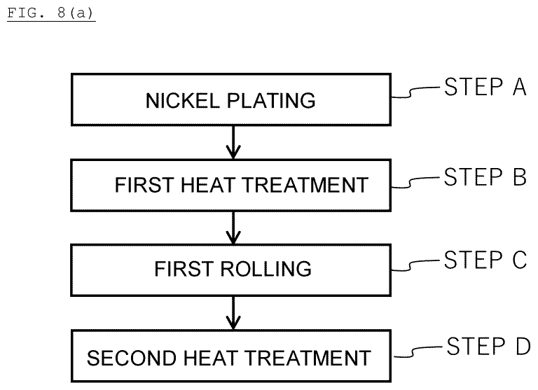

In the surface treated steel foil 10 in the present embodiment, the roughened nickel layer 50 may further be formed at the outermost surface as depicted in FIG. 6. Note that the above-described metallic layer 40 may be the roughened nickel layer. Note that the roughened nickel layer may be formed on the above-mentioned metallic layer 40 as depicted in FIG. 7.

The roughened nickel layer 50 may be formed on the side of the second surface 10b of the surface treated steel foil 10 as depicted in FIG. 6(a), may be formed on the side of the first surface 10a as depicted in FIG. 6(b), or may be formed on both sides. Note that, since the roughened nickel layer is described, for example, in the present inventors' application (WO2021/020338 and the like), the details thereof are omitted here, but it is preferable, in terms of enhancing adhesion with an active material, that a three-dimensional surface property parameter Sa of the roughened nickel layer be 0.2 to 1.3 μm, more preferably 0.36 to 1.2 μm. Note that it is preferable that the three-dimensional surface property parameter Sa be measured by use of a laser microscope.

Note that, in forming the roughened nickel layer 50, from a viewpoint of adhesion between the roughened nickel layer 50 and an underlying layer, a ground nickel layer may be formed prior to roughened nickel plating, further the roughened nickel plating may be performed, and thereafter coating nickel plating may be conducted to form the roughened nickel layer. In other words, nickel plating formed as the metallic layer 40 on the iron-nickel alloy layer may be regarded as the ground nickel layer, and the roughened nickel layer 50 may be formed thereon. In addition, a metallic layer 40 obtained by a heat treatment in forming the iron-nickel alloy layer so performed as to leave a nickel layer in which iron is little diffused on the iron-nickel alloy layer and further performing nickel plating thereon may be regarded as the ground nickel layer, and the roughened nickel layer 50 may be formed thereon. Besides, the description of the above-mentioned metallic layer 40 or the “roughened nickel layer 50” herein may include a coating nickel layer. Note that the details of the ground nickel layer, the roughened nickel layer, and the coating nickel layer will be described later.

In the case where the roughened nickel layer 50 is formed, the total of the nickel deposition amounts in the iron-nickel alloy layer 30 and the roughened nickel layer 50 is preferably 9 to 106 g/m², more preferably 15 to 70 g/m², and further preferably 27 to 60 g/m².

In the case where the roughened nickel layer 50 is formed and where the roughened nickel layer 50 is formed on the metallic layer 40 composed of nickel, the total of the nickel deposition amounts in the iron-nickel alloy layer 30, the metallic layer 40, and the roughened nickel layer 50 is preferably 9 to 106 g/m², more preferably 15 to 70 g/m², and further preferably 27 to 60 g/m².

Note that, as the method for measuring the nickel deposition amount in the roughened nickel layer 50, the methods described in WO2020/017655, WO2021/020338, and the like can appropriately be adopted. In other words, the nickel deposition amount can be determined by measuring the total nickel amount in the surface treated steel foil 10 for the current collector by use of XRF or the like.

In the present embodiment, as a surface roughness in the case where the roughened nickel layer 50 of the surface treated steel foil is not formed, Sz is preferably not less than 1.0 μm.

In other words, the surface roughness Sz of the surface of the alloy layer 30 or the metallic layer 40 on the side where the roughened nickel layer is not formed in the case where the roughened nickel layer 50 is formed only on one surface side, or the surface roughness Sz of the iron-nickel alloy layer 30 or the metallic layer 40 at the surface of the surface treated steel foil in the case where the roughened nickel layer 50 is formed on none of both surface sides, is preferably not less than 1.0 μm.

The reason for this is that, in order to cause the surface roughness Sz to be less than 1.0 μm, it is necessary to reduce not only the finishing roll roughness but also the roll roughness at intermediate stages, and it is difficult to obtain a target steel foil thickness.

In addition, particularly in the case of current collector use, the above-mentioned surface roughness Sz is more desirably not less than 1.5 μm, since a certain level of adhesion is desired even through an adhesion comparable to that of the roughened nickel layer is not needed.

On the other hand, if the surface roughness Sz is too high, there is a fear of influence of non-uniformity of the surface, and hence, Sz is preferably not more than 15 μm, more preferably not more than 10 μm.

### <<Manufacturing Method for Surface Treated Steel Foil>>

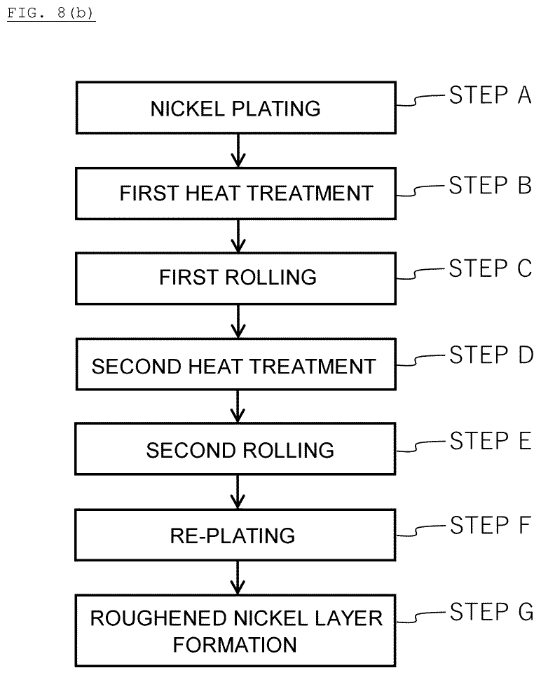

An example of the manufacturing method for the surface treated steel foil 10 in the present embodiment will be described with reference to FIG. 8.

An example of the manufacturing method in the present embodiment includes a step of forming a nickel plating layer on a raw sheet as a base material to obtain a nickel-plated material (STEP A: nickel plating step), a step of subjecting the nickel-plated material to a heat treatment (STEP B: first heat treatment step), a step of subjecting the nickel-plated material having undergone the heat treatment to rolling (STEP C: first rolling step), and a step of subjecting the rolled nickel-plated material to a second heat treatment (STEP D: second heat treatment step), in this order, as depicted in FIG. 8(a).

The surface treated steel foil obtained by the manufacturing method in the present embodiment is characterized in that Fe₁Ni₁ is contained as an alloy phase in the iron-nickel alloy layer, the orientation index in X-ray diffraction of the (220) plane of Fe₁Ni₁ in the surface having the iron-nickel alloy layer is not less than 1.0, and (c) the ratio of the maximum value of diffraction intensity of the (220) plane of Fe₁Ni₁ and the maximum value of diffraction intensity of the Fe(200) plane satisfies the following formula (1).

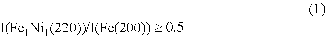

In addition, STEP C and STEP D may be repeated after STEP D.

Note that the rolling in the above-mentioned “first rolling step” is also called “re-rolling” in an implication of discriminating it from the rolling of the raw sheet.

Besides, the heat treatment in the above-mentioned “second heat treatment step” is also referred to simply as a “second heat treatment.”

In addition, for the purpose of further thickness adjustment or tempering or the like, the manufacturing method may further include sequentially a second rolling step (STEP E), as depicted in FIG. 8(b). Note that, even in the case where this second rolling step is conducted, it is preferable that the above formula (1) be satisfied.

The manufacturing method may further include a re-plating step (STEP F) and a roughened nickel layer forming step (STEP G), after STEP D or STEP E.

Each of the steps will be described in detail below.

### <Preliminary Step>

First, a steel sheet to be the raw sheet is prepared.

The raw sheet here is a steel sheet, before the rolling described below, of steel constituting a base material part when a surface treated steel foil is obtained through the steps described later. Hence, as with the base material, the steel sheet as the raw sheet is preferably a low carbon steel or an ultra low carbon steel. Besides, the raw sheet is preferably a cold rolled steel sheet.

The thickness of the raw sheet is not particularly limited to any value, but in order to obtain a material having a thickness in such an extent as to be called a steel foil after the first rolling step described later, the raw sheet is preferably 150 to 500 μm in thickness.

In order to obtain a foil having a thickness of not more than 120 μm after the first rolling step described later, the thickness of the raw sheet is more preferably not more than 400 μm. This is because a thinner raw sheet promises mitigation of the draft in rolling and easier prevention of exposure of iron.

In order to obtain a foil having a thickness of less than 100 μm after the first rolling step described later, the thickness of the raw sheet is more preferably not more than 350 μm, and particularly preferably not more than 300 μm.

Note that, in the case where a cold rolled steel sheet is used as the raw sheet, “annealing” generally performed for removal of work hardening of a cold rolled steel sheet can be carried out before the nickel plating step described later.

In addition, in the present embodiment, this “annealing” of the cold rolled steel sheet can be omitted, since in the first heat treatment step conducted for the main purpose of softening of the nickel plating described later, the removal of work hardening of the cold rolled steel sheet can be concurrently performed.

### <Step A: Nickel Plating Step>

The nickel plating step is a step in which nickel necessary for forming the iron-nickel alloy layer 30 to be formed by the second heat treatment described later is given to at least one surface side of the above-mentioned raw sheet as a nickel plating layer.

In the nickel plating step, the nickel plating deposition amount to be given to the raw sheet is preferably 7.2 to 89.0 g/m² per one surface side. More preferably, the nickel plating is applied to both surfaces in an amount of 7.2 to 89.0 g/m² per one surface side, is applied to at least one surface in an amount of more preferably not less than 10 g/m² per one surface side, and particularly preferably not less than 13.0 g/m². Note that the upper limit is more preferably not more than 72.0 g/m², and further preferably not more than 63.0 g/m².

In the case where the nickel plating deposition amount exceeds 89.0 g/m², productivity is poor, and even if the first heat treatment step is conducted, the foil may be broken due to insufficient elongation of the foil as a whole upon the first rolling step.

On the other hand, in the case where the nickel plating deposition amount is less than 7.2 g/m², nickel in the iron-nickel alloy layer 30 obtained finally after the second heat treatment step is insufficient, so that it may be impossible to obtain a sufficient amount of Fe₁Ni₁, or it may be impossible to obtain the required hydrogen barrier properties since exposure of iron cannot be restrained.

Note that the nickel plating deposition amount can be converted into the thickness of the nickel plating by dividing it by a specific gravity of nickel, 8.9. Hence, by summing up the thickness of the raw sheet and the thickness of the nickel plating, the thickness before the first rolling can be determined.

In the nickel plating step, as the plating conditions and the like for electroplating, known conditions are applicable. An example of the plating conditions will be indicated below.

### [Nickel Plating Bath and Example of Plating Conditions]

Bath composition: known Watts bath
   Nickel sulfate hexahydrate: 200 to 300 g/L
   Nickel chloride hexahydrate: 20 to 60 g/L
   Boric acid: 10 to 50 g/L
   Bath temperature: 40° C. to 70° C.
   pH: 3.0 to 5.0
   Stirring: air stirring or jet stirring
   Current density: 5 to 30 A/dm²

Note that, in regard of the bath composition, not only the Watts bath, but also a known nickel sulfamate bath or a citric acid bath may be used. Further, additives such as a known brightening agent may be added to the plating bath, to perform bright nickel plating or semi-bright nickel plating.

### <Step B: First Heat Treatment Step>

Next, the first heat treatment step will be described. The first heat treatment step is a heat treatment step performed first after the above-mentioned nickel plating step, and is carried out in a reducing atmosphere. The first heat treatment step is a step for the main purpose of softening the nickel plating layer formed in the above-mentioned nickel plating step, prior to the rolling step described later.

In the case where rolling is conducted without carrying out the heat treatment after the nickel plating, no problem is generated if the rolling is in an extent of temper rolling, but in the case where the raw sheet having a thickness of 0.15 to 2.0 mm is subjected to rolling with a draft in excess of 35% to obtain a surface treated metallic foil having a thickness of 10 to 200 μm, as manufacture of a foil, the nickel plating layer in an as-is state may be too hard to manufacture the foil, or the nickel plating layer may be peeled off, so that the surface treated steel foil having the intended iron-nickel alloy layer cannot be manufactured. In view of this, the heat treatment is conducted for the purpose of softening the nickel plating layer.

As the heat treatment conditions for the first heat treatment step, conditions under which nickel in the nickel plating layer is sufficiently softened to such an extent that the first rolling step described later is possible are applicable. For example, the heat treatment conditions in a known batch annealing (box annealing) or continuous annealing can be applied.

As an example of temperature and time in the case of a continuous annealing treatment, the annealing is preferably conducted at 600° C. to 950° C. for a soaking time in the range of 15 to 150 seconds. In the case of a lower temperature or a shorter time than this set of conditions, softening is insufficient, and it may be difficult to form a foil by rolling in the first rolling step conducted thereafter, which is unfavorable. On the other hand, in the case of a higher temperature and a longer time than the above-mentioned heat treatment ranges, variation in the mechanical properties of the steel foil to be the base material is large, strength is markedly lowered, which is unfavorable, also from a viewpoint of cost.

In addition, for sufficient softening, the soaking time is more preferably 20 to 150 seconds.

As an example of temperature and time in the case of the batch annealing (box annealing), the annealing is preferably carried out at a temperature of 450° C. to 690° C. for a soaking time of 1.5 to 20 hours, and a total time of heating, soaking, and cooling of 4 to 80 hours. In the case of a lower temperature or a shorter time than this set of conditions, softening is insufficient, and it may be difficult to form a foil by rolling in the first rolling step conducted thereafter, which is unfavorable. On the other hand, in the case of a higher temperature or a longer time than the above-mentioned heat treatment ranges, variations in the mechanical properties of the steel foil as the base material or the like are large, and strength might be conspicuously lowered, which is unfavorable, or such a higher temperature or a longer time is unfavorable in terms of cost.

It is to be noted, however, in the case where the deposition amount of the nickel plating is not more than 54.0 g/m² per one surface side, particularly where the deposition amount on one surface side is as small as not more than 27.0 g/m², if a heat treatment at a higher temperature or for a longer time is conducted, the amount of nickel necessary for alloying of exposed iron at the time of the second heat treatment may be deficient, so that, for example, continuous annealing at a temperature of less than 780° C. is preferable, more preferably less than 750° C.

Note that, when the first heat treatment step has been conducted, iron in the raw sheet and nickel in the nickel plating layer are mutually diffused by heat, to form an iron-nickel diffusion layer. In other words, on the surface to which nickel plating has been applied in the above-mentioned nickel plating step, an iron-nickel diffusion layer or the iron-nickel diffusion layer and a soft nickel layer are formed at the time point when the first heat treatment step has been conducted. In other words, the iron-nickel diffusion layer in the present embodiment refers to an alloy layer that is obtained by the heat treatment of iron and nickel and that does not satisfy either the above-mentioned characteristic (b) or the above-mentioned characteristic (c). In addition, the soft nickel layer in the present embodiment refers to such a softened nickel layer that iron in the raw sheet is not diffused into nickel of the nickel plating layer by the heat treatment.

Note that it is sufficient if the Fe₁Ni₁ alloy phase necessary for hydrogen barrier properties in the present embodiment is formed at the time point when the second heat treatment step described later has been conducted. Hence, at the time point when the first heat treatment has been conducted, the Fe₁Ni₁ alloy phase may have been formed or may not have been formed.

Note that the thickness of the heat-treated steel sheet having undergone the first heat treatment step is not different from the thickness of the nickel-plated steel sheet upon the nickel plating.

### <Step C: First Rolling Step>

Next, the first rolling step in the manufacturing method in the present embodiment will be described. The first rolling step in the present embodiment is a step of rolling the nickel-plated material having undergone the heat treatment after the above-mentioned nickel plating step and the first heat treatment step are conducted. The first rolling step is for the purpose of obtaining a desired foil thickness, or preliminarily obtaining a foil thickness which is free of problem in obtaining a desired foil thickness at the time point when the second rolling step described later has been conducted.

The draft in the first rolling step is preferably not less than 35%. With the draft set to be not less than 35%, a large working distortion having orientation in the Fe₁Ni₁(220) plane in such an extent as not to be collapsed even when the later second heat treatment is conducted can be imparted to the iron-nickel diffusion layer. By causing orientation not only in the Fe₁Ni₁(200) plane but also in the Fe₁Ni₁(220) plane as described above, the hydrogen passages can be complicated and the hydrogen barrier properties can be enhanced. In addition, the texture oriented into the Fe₁Ni₁(220) retains the Fe₁Ni₁(220) orientation when the crystals of the iron-nickel alloy are recrystallized at the time of the second heat treatment and the crystal grains are coarsened, or when alloying proceeds and the thickness of the iron-nickel alloy layer increases. In the case of a draft of less than 35%, since the above-mentioned exposure of iron hardly occurs, so that the problem of lowering in the hydrogen barrier properties does not occur. In addition, with respect to the crystal orientation of the iron-nickel alloy layer, orientation into the Fe₁Ni₁(220) in such an extent as to remain after the later second heat treatment is hardly be generated.

While a lower draft is preferable for restraining exposure of iron, in order to leave the above-mentioned orientation in the Fe₁Ni₁(220) plane even after the heat treatment, the draft is preferably not less than 35%, more preferably not less than 50%. In addition, at the time of rolling to a foil, the thickness constituting the denominator of the draft, or the thickness before rolling, is smaller, so that the draft becomes somewhat high, as compared to the case of ordinary rolling from a thicker sheet to a thinner sheet; particularly at the time of forming a foil of less than 100 μm in thickness, the draft becomes not less than 50%. It is to be noted, however, that the amount of the exposed part of iron increases as the draft becomes higher. Hence, the draft is preferably not more than 85%, more preferably not more than 80%, further preferably not more than 78%, and particularly preferably not more than 75%.

Rolling mill rolls acting in the first rolling step may be one set or may be a plurality of sets of rolls. Normally, a rolling mill is configured by combining pluralities of upper and lower rolls, or rolling mill rolls, directly acting on a sheet to thin the sheet and rolls for passing the sheet therethrough. At the time of rolling, one set of rolling mill rolls may act for rolling, or a plurality of sets of rolling mill rolls may act. In the present embodiment, the rolling mill rolls acting in the first rolling step may be one set or a plurality of sets of rolls; in addition, for example, the sheet may be passed twice through three sets of rolling mill rolls to roll the sheet by a total of six sets of rolling mill rolls. In general, when the number of times a sheet is passed through the rolling mill rolls increases, a trouble due to work hardening is liable to occur upon rolling. Hence, the rolling mill rolls acting for rolling are preferably not more than six sets, more preferably not more than four sets. Note that, here, one set of rolling mill rolls is counted in terms of the upper and lower rolls which directly act on the sheet and across which the thickness of the sheet changes.

In addition, the above-mentioned draft refers to a draft obtained from the thicknesses before and after the first rolling step. In other words, when a sheet is passed twice through three sets of rolling mill rolls, the draft refers to the draft obtained from the thickness of the sheet before the first passing and the thickness of the sheet after the second passing.

In the first rolling step, the draft by the first set of rolling mill rolls is not particularly limited to any value, but from a viewpoint of the fact that exposure of iron is easily controllable by thinning the sheet at the time when the sheet is in the first most soft state, the draft is preferably set not less than 35%. It is to be noted, however, that, from a viewpoint of the fact that, since the thickness of the sheet is largest before rolling through the first set of rolling mill rolls, too high a draft makes it difficult to control the uniformity of thickness, the draft by the first set of rolling mill rolls is preferably less than 50%.

Note that the nickel deposition amount on a steel foil after the first rolling step, that is, the amount of nickel per area after the nickel imparted by the nickel plating step is elongated by rolling, is preferably in excess of 5.0 g/m² on at least one surface side, more preferably not less than 6.0 g/m², and further preferably not less than 6.5 g/m², in terms of hydrogen barrier properties. Besides, in order to obtain more stable hydrogen barrier properties, the nickel deposition amount is preferably in excess of 5.0 g/m² on each of both surface sides of the steel foil.

### <Step D: Second Heat Treatment Step>

Next, a second heat treatment step in the manufacturing method in the present embodiment will be described.

The second heat treatment step is a step of subjecting the material having undergone the above-mentioned first rolling step to annealing in a reducing atmosphere.

This second heat treatment step is carried out for the purpose of forming a Fe₁Ni₁ alloy phase in the iron-nickel alloy layer, setting the orientation index in X-ray diffraction of the (220) plane of Fe₁Ni₁ to be not less than 1.0, or causing the ratio of the diffraction intensity of the (220) plane of Fe₁Ni₁ and the diffraction intensity of the Fe(200) plane to satisfy the following formula (1).

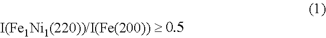

More in detail, first, the iron-nickel diffusion layer formed on the surface by the above-mentioned first heat treatment, or the iron-nickel diffusion layer and the soft nickel layer, are rolled together with the raw sheet in the first rolling step. By this rolling, the thickness of the material is decreased, and the orientation in the Fe₁Ni₁(220) plane is increased. In addition, parts where the iron-nickel diffusion layer, or the iron-nickel diffusion layer and the soft nickel layer, are partially extremely thinned are liable to be generated, and iron of the raw sheet may be exposed.

Hence, at the time point when the first rolling step has been conducted, the effective hydrogen barrier properties obtained upon the first heat treatment step may be lowered.

In this second heat treatment step, Fe₁Ni₁ effective for the hydrogen barrier properties is formed sufficiently, alloying of the parts where the thickness of the material is extremely reduced or the parts where iron of the raw sheet is exposed (hereinafter, referred to also as “alloying of the deficient parts”) is contrived, and a configuration satisfying the above-mentioned formula (1) is realized, whereby the hydrogen barrier properties can be recovered.

As for the heat treatment conditions in the second heat treatment step, the conditions for satisfying the formula (1) differ according to the state of the steel foil before the second heat treatment.

As an example, in the case where the second heat treatment step is continuous annealing, the annealing is carried out at 680° C. to 950° C. for a soaking time in the range of 30 to 150 seconds. On the other hand, in the case where the second heat treatment step is batch annealing (box annealing), the annealing is carried out under the conditions of a temperature of 500° C. to 650° C., a soaking time of 1.5 to 20 hours, and a total time of heating, soaking, and cooling times in the range of 4 to 80 hours.

In the case of a lower heat treatment temperature or a shorter time than the above-mentioned ranges, sufficient Fe₁Ni₁ may not be formed, or/and the alloying of the parts where the thickness is extremely reduced by rolling or the parts where iron of the base material is exposed may be insufficient, and the hydrogen barrier properties may be worsened, which is unfavorable.

In addition, the conditions constituting a configuration satisfying the formula (1) are not limited, but particularly when the draft in the above-mentioned first rolling step is not less than 50%, for forming sufficient Fe₁Ni₁ in this second heat treatment step and for alloying of the deficient parts, in the case of the continuous annealing, the annealing is preferably carried out under the conditions of a temperature of 700° C. to 750° C. and a soaking time of 60 to 150 seconds or a temperature of not less than 760° C., and in the case of box annealing, the annealing is preferably carried out under the conditions of a temperature of not less than 500° C. and less than 540° C. and a soaking time of not less than four hours or a temperature of not less than 540° C.

Note that the nickel deposition amount of the surface treated steel foil obtained at a time point when the second heat treatment step has been conducted does not differ from the nickel deposition amount at a time point when the above-mentioned first rolling step has been conducted.

In the case of the continuous steel strip, a surface treatment for preventing close adhesion of the nickel plating may be conducted before the second heat treatment step. As the surface treatment for preventing the close adhesion of the nickel plating, there may be mentioned, for example, the formation of a layer of a silicon oxide by use of a bath containing sodium orthosilicate as a main constituent as disclosed in Japanese Patent Laid-open No. Hei 08-333689. Note that this surface treatment for preventing the close adhesion of the nickel plating may be removed after the second heat treatment step.

### <Step E: Second Rolling Step>

Next, a second rolling step after the second heat treatment step will be described. This second rolling step is a step for the purpose of further thickness adjustment, tempering, or the like of the surface treated steel foil. Note that this second rolling step is not an indispensable step and may be omitted as required.

In this second rolling step, the draft (the draft calculated from the difference in thickness across the second rolling step) is preferably less than 35%, more preferably not more than 33%, and further preferably not more than 25%. There is no particular lower limit for the draft, and the draft inclusive of that of temper rolling in which the thickness is substantially not changed is not less than 0%.

Note that, at the time point when this second rolling step has been conducted, it is necessary to satisfy the above-mentioned formula (1).

In addition, since the nickel deposition amount is reduced according to the draft in the second rolling step, a preferable nickel deposition amount should be realized in the state after the second rolling, in the case where the second rolling step is conducted.

The preferable nickel deposition amount after the second rolling, in terms of hydrogen barrier properties, is preferably in excess of 5.0 g/m² on at least one surface side, more preferably not less than 6.0 g/m², and further preferably not less than 6.5 g/m². In addition, in order to obtain more stable hydrogen barrier properties, the nickel deposition amount is preferably in excess of 5.0 g/m² on each of both surface sides of the steel foil.

### <Step F: Re-Plating Step>

The surface treated steel foil 10 may further have a metallic layer 40 on the iron-nickel alloy layer 30. There are mainly two forming methods for this metallic layer 40. A first method is a method of forming the metallic layer 40 by leaving a nickel layer almost free of diffusion of iron as the metallic layer 40, in the above-mentioned first heat treatment step and second heat treatment step.

A second method is a method of forming the metallic layer 40 by conducting a step of plating to form the metallic layer 40 (re-plating step) after any one of the first rolling step, the second heat treatment step, and the second rolling step. Note that the metallic layer 40 may be formed by use of both the first method and the second method.

In the above-mentioned re-plating step, a nickel layer, a chromium layer, or the like may be mentioned as the metallic layer 40. In the case of forming a nickel layer as the metallic layer 40 in the re-plating step, the nickel layer can be formed by use of a known nickel bath such as the above-mentioned Watts bath, a nickel sulfamate bath, and a citric acid bath.

Note that, in the case where the nickel layers are formed by both the above-mentioned first method and the second, re-plating step, the two nickel layers can be dealt with as one nickel layer. In the case where a metallic layer composed of metal other than nickel, such as a chromium layer, is formed in the second, re-plating step, there may be a plurality of metallic layers.

Note that it is preferable, in terms of adhesion with the roughened nickel layer which will be described later, that a heat treatment be not conducted after the formation of the metallic layer.

In the case where nickel plating is conducted in the re-plating step, the total nickel deposition amount of the surface treated steel foil inclusive of the deposition amount by the re-plating is preferably 2.22 to 53.4 g/m², in terms of hydrogen barrier properties, liquid electrolyte resistance, and the like suitable for bipolar batteries. A more preferable deposition amount is 2.22 to 26.7 g/m². Note that the nickel deposition amounts in the iron-nickel alloy layer 30 and the metallic layer 40 can be measured by XRF or the like.

### <Step G: Roughened Nickel Layer Forming Step>

In addition, the manufacturing method for the surface treated steel foil 10 in the present embodiment may include a step of forming the roughened nickel layer 50 at the outermost surface. Note that a plating bath for forming the roughened nickel layer has a chloride ion concentration of preferably 3 to 90 g/L, more preferably 3 to 75 g/L, and further preferably 3 to 50 g/L, the ratio between nickel ions and ammonium ions in terms of weight ratio of “nickel ions/ammonium ions” of preferably 0.05 to 0.75, more preferably 0.05 to 0.60, further preferably 0.05 to 0.50, and still further preferably 0.05 to 0.30, and a bath conductivity at 50° C. of preferably 5.00 to 30.00 S/m, more preferably 5.00 to 20.00 S/m, and further preferably 7.00 to 20.00 S/m. Note that, in the case where the chloride ion concentration is not less than 10 g/L, a favorable roughened plating state can easily be realized even if the deposition amount in the roughened nickel plating is somewhat small. The method for adjusting the chloride ion concentration, the ratio between nickel ions and ammonium ions, and bath conductivity of the plating bath within the above-mentioned ranges is not particularly limited to any method; for example, there may be mentioned a method in which the plating bath contains nickel sulfate hexahydrate, nickel chloride hexahydrate, and ammonium sulfate, and the blending amounts of these compounds are appropriately adjusted. An example of plating conditions is as follows.

### <<Example of Roughened Nickel Plating Conditions>>

Bath composition: nickel sulfate hexahydrate 10 to 100 g/L, nickel chloride hexahydrate 1 to 90 g/L, ammonium sulfate 10 to 130 g/L
   pH 4.0 to 8.0
   Bath temperature 25° C. to 70° C.
   Current density 4 to 40 A/dm²
   Plating time 10 to 150 seconds
   Presence/absence of stirring: Air stirring or jet stirring

Note that the addition of ammonia to the nickel plating bath may be conducted by use of ammonia water, ammonium chloride, or the like in place of ammonium sulfate. The ammonia concentration in the plating bath is preferably 6 to 35 g/L, more preferably 10 to 35 g/L, further preferably 16 to 35 g/L, and still further preferably 20 to 35 g/L. Besides, in order to control the chloride ion concentration, use may be made of a basic nickel carbonate compound, hydrochloric acid, sodium chloride, potassium chloride, or the like.

The three-dimensional surface property parameter Sa of the roughened nickel layer 50 is preferably 0.2 to 1.3 μm as described above. To set the numerical value of the three-dimensional surface property parameter Sa of the roughened nickel layer 50 within this range, for example, control of surface roughness of the base material 20, adjustment of the roughened nickel plating conditions and the thickness, adjustment of the ground nickel plating conditions and the thickness, adjustment of the coating nickel plating conditions and the thickness, and the like may be adopted.

Note that, as a post-stage of the roughened nickel plating, a coating nickel plating layer may be formed, as disclosed in WO2020/017655. Note that, as the coating nickel plating conditions, the contents disclosed in WO2020/017655 is applicable, so that the detailed description thereof is omitted here.

Note that, in the manufacturing method for the surface treated steel foil 10 in the present embodiment, a continuous manufacturing system (for example, a roll-to-roll system) is applicable, and a batch type manufacture using a cut sheet, for example, can also be adopted.

The surface treated steel foil obtained by such a manufacturing method as described above preferably has a hydrogen permeation current density (oxidation current value) of not more than 55 μA/cm², which is suitable for a bipolar electrode, in terms of hydrogen barrier properties. Note that, in the present embodiment, the hydrogen permeation current density (oxidation current value) means a current value on the hydrogen detection side in the case of measurement under the conditions of a potential on the cathode side of −1.5 V and a potential on the anode side of +0.4 V in a liquid electrolyte at 65° C., using the device described in FIGS. 2(a) and 2(b).

### EXAMPLES

The present invention will be described more specifically below by using Examples. First, measuring methods in Examples will be described.

### [X-Ray Diffraction (XRD) Measurement]

The alloy phase in the iron-nickel alloy layer was specified by X-ray diffraction. The surface treated steel foil was subjected to X-ray diffraction, and the orientation index and the peak intensity ratio (the ratio of the maximum values of diffraction intensity) were obtained from the measurement results.

As an X-ray diffractometer, SmartLab made by Rigaku Corporation was used. As the specimen, the surface treated steel foil was cut to 20×20 mm and used.

The diffraction intensity of the Fe₁Ni₁(220) crystal plane was confirmed at the following diffraction angle 2θ.
Fe₁Ni₁(220) crystal plane: diffraction angle 2θ=75.1°±0.11°

The diffraction intensities of crystal planes of iron were confirmed at the following diffraction angles 2θ.
Fe(200) crystal plane: diffraction angle 2θ=65.02°±0.11°
Fe(211) crystal plane: diffraction angle 2θ=82.33°±0.11°

In addition, for calculation of the orientation index, the diffraction intensities of crystal planes of Fe₁Ni₁ were confirmed at the following diffraction angles 2θ.
Fe₁Ni₁(111) crystal plane: diffraction angle 2θ=43.83°±0.11°
Fe₁Ni₁(200) crystal plane: diffraction angle 2θ=51.05°±0.11°
Fe₁Ni₁(311) crystal plane: diffraction angle 2θ=91.23°±0.11°
Fe₁Ni₁(222) crystal plane: diffraction angle 2θ=96.56°±0.11°

Further, for determining the presence of the crystal plane (220) in the crystal structure of Fe₁Ni₁, diffraction intensity was confirmed at the following diffraction angle 2θ.
Diffraction angle 2θ=86°±0.5°

Note that specific measurement conditions in the X-ray diffraction were the following specifications.

### <Device Configuration>

X-ray source: CuKα
Goniometer radius: 300 nm
Optical system: concentration method

### (Incidence Side Slit System)

Solar slit: 5°
Longitudinal limit slit: 5 mm
Divergence slit: ⅔°

### (Light Reception Side Slit System)

Scattering slit: ⅔°
Solar slit: 5°
Light reception slit: 0.3 mm
Monochromating method: counter monochromator method
Detector: scintillation counter

### <Measurement Parameters>

Tube voltage-tube current: 45 kV 200 mA
Scanning axis: 2θ/θ
Scanning mode: continuous
Measuring range: 2θ 40° to 100°
Scanning speed: 10°/min
Step: 0.02°

The ratio of the diffraction intensity of the Fe₁Ni₁(220) plane in the crystal structure of Fe₁Ni₁ and the diffraction intensity of the Fe(200) plane, which are obtained at the above-mentioned diffraction angles, is indicated in the columns of “Fe₁Ni₁(220)/Fe(200)” in Tables 1 to 4. The ratio of Fe(211)/Fe(200) is similarly indicated in Tables 1 to 4. In addition, as for the presence of Fe₁Ni₁, in the case where the maximum value of diffraction intensity at the direction angle 2θ=75.1°±0.110 is not less than twice the average value of diffraction intensity at 2θ=86°±0.5°, it is determined that Fe₁Ni₁ is present, and in the case where the maximum value is less than twice the average value, it is determined that Fe₁Ni₁ is absent and it is written as “-” in Tables 1 to 4.

The crystal orientation index Ico_Fe₁Ni₁(220) in X-ray diffraction of the (220) plane of Fe₁Ni₁ is calculated by the following formula, and is indicated in the columns of “Fe₁Ni₁(220) orientation index” in Tables 1 to 4.

$$\\ [ {I\_Fe}_{1} {Ni}_{1} ( 220 ) / [ \begin{matrix}{I\_Fe}_{1} {Ni}_{1} ( 111 ) + {I\_Fe}_{1} {Ni}_{1} ( 200 ) + \\ {I\_Fe}_{1} {Ni}_{1} ( 220 ) + {I\_Fe}_{1} {Ni}_{1} ( 311 ) + {I\_Fe}_{1} {Ni}_{1} ( 222 )\end{matrix} ] ] / [ {I}_{s} {\_Fe}_{1} {Ni}_{1} ( 220 ) / [ \begin{matrix}{I}_{s} {\_Fe}_{1} {Ni}_{1} ( 111 ) + {I}_{s} {\_Fe}_{1} {Ni}_{1} ( 200 ) + \\ {I}_{s} {\_Fe}_{1} {Ni}_{1} ( 220 ) + {I}_{s} {\_Fe}_{1} {Ni}_{1} ( 311 ) + {I}_{s} {\_Fe}_{1} {Ni}_{1} ( 222 )\end{matrix} ] ]$$

Here, the diffraction intensity of each crystal plane of Fe₁Ni₁ in the above calculating formula is the maximum value of diffraction intensity confirmed at each diffraction angle 2θ, as follows.
I_Fe₁Ni₁(111): diffraction intensity of Fe₁Ni₁(111) crystal plane measured at diffraction angle 2θ=43.83°±0.11°
I_Fe₁Ni₁ (200): diffraction intensity of Fe₁Ni₁ (200 crystal plane measured at diffraction angle 2θ=51.05°±0.11°
I_Fe₁Ni₁(220): diffraction intensity of Fe₁Ni₁(220) crystal plane measured at diffraction angle 2θ=75.1°+0.11°
I_Fe₁Ni₁(311): diffraction intensity of Fe₁Ni₁(311) crystal plane measured at diffraction angle 2θ=91.23°±0.11°
I_Fe₁Ni₁(222): diffraction intensity of Fe₁Ni₁(222) crystal plane measured at diffraction angle 2θ=96.56°±0.11°

In addition, in the calculating formula for the crystal orientation index, Iₛ_Fe₁Ni (111), Iₛ_Fe₁Ni₁ (200), Iₛ_Fe₁Ni₁ (220), Iₛ_Fe₁Ni₁ (311), and Iₛ_Fe₁Ni₁ (222) are standard diffraction peak intensity values of crystal planes ((111) plane, (200) plane, (220) plane, (311) plane, and (222) plane) of Fe₁Ni₁ which are described in JCPDS (PDF card No.: 01-071-8322).

[Measuring Method for Thickness of Iron-Nickel Alloy Layer after Heat Treatment]

Calculation of the thickness of the iron-nickel alloy layer was conducted by an analysis by SEM-EDX (device name SU8020 made by Hitachi High-Tech Corporation and EDAX made by AMETEK, Inc.), specifically by linear analysis of elemental analysis of Ni and Fe at a depth of up to 10 μm in the depth direction from a surface layer. Note that measurement conditions were an accelerating voltage of 15 kV, an observation magnification of 5,000, and a measurement step of 0.1 μm. As depicted in FIG. 3, the axis of abscissas represents the distance (μm) in the depth direction from the surface layer, the axis of ordinates represents X-ray intensity of Ni and Fe, and at parts around an intersection between a curve of nickel and a curve of iron, the distance between 1/10 times the maximum value of nickel and 1/10 times the maximum value of iron was deemed as the thickness of the iron-nickel alloy layer 30, and the thickness was read from the graph.

### [Hydrogen Permeation Current Density Measuring Method]

By use of the device depicted in FIG. 2, measurement was conducted using an evaluation sample as a working electrode and using Ag/AgCl as a reference electrode under the conditions of a potential on the hydrogen generation side (cathode side) of −1.5 V and a potential on the hydrogen detection side (anode side) of +0.4 V. Note that, as a detailed measuring method, measurement was conducted using the device depicted in FIG. 2(a) as described above. As a liquid electrolyte, use was made of an alkaline aqueous solution at 65° C., containing 6 mol/L of KOH as a main constituent and containing KOH, NaOH, and LiOH with a total concentration of KOH, NaOH, and LiOH of 7 mol/L. As potentiostat, a “multi-electrochemical measurement system HZ-Pro” made by HOKUTO DENKO CORPORATION was used. First, a potential of +0.4 V was applied on the hydrogen detection side and was maintained for 60 minutes for stabilization of current value. Note that the hydrogen detection side was continuedly maintained at the same potential. Next, a potential was applied stepwise on the hydrogen invasion side as −0.7 V, −1.1 V, and −1.5 V, each of the potentials being applied for 15 minutes. Note that variation in oxidation current while the potential on the hydrogen invasion side was −1.5 V was regarded as a hydrogen permeation current density, which was an evaluation object in Examples and Comparative Examples. The measurement diameter was φ20 mm, and the measurement area was 3.14 cm².

The hydrogen permeation current density I (μA/cm²) obtained from the following formula (1) was set forth in Table 1.

$$\\ \begin{matrix}Hydrogen permeation current density I ( µ A / {cm}^{2} ) = ( ( average value of oxidation current from Ib to Ic ) / S ) - ( ( average of Ia and Id ) / S ) & ( 1 )\end{matrix}$$

where Ia (μA) is oxidation current at five seconds before application of −1.5 V, Ib (μA) is oxidation current at 155 seconds after the start of application of −1.5 V, Ic (μA) is oxidation current at end of application of −1.5 V, Id (μA) is oxidation current at 155 seconds after the end of application of −1.5 V, and S (cm²) is the measurement area (evaluation area).

Note that, at the time of hydrogen permeation current density measurement for samples other than Examples 9 to 11 and Comparative Example 1, the following measurement nickel films of 1 μm in thickness were formed on the respective surfaces on both sides of a surface treated steel foil, and thereafter the hydrogen permeation current density was measured.

### <Measurement Nickel Plating Conditions>

Bath composition: nickel sulfate hexahydrate 250 g/L, nickel chloride hexahydrate 45 g/L, boric acid 30 g/L
   pH 4.0 to 5.0
   Bath temperature 60° C.
   Current density 10 A/dm²

### [Three-Dimensional Surface Property Parameter (Sa) Measuring Method]

With respect to the surface of the roughened nickel layer 50 of the surface treated steel foil, each three-dimensional surface property parameter (arithmetic mean height Sa) was measured by use of a laser microscope (3D measurement laser microscope LEXT OLS5000, made by Olympus Corporation) according to ISO 25178-2: 2012.

Specifically, first, under the condition of an objective lens with a magnification of 100 (lens name: MPLAPON100XLEXT), an analysis image in a visual field of 128×128 μm was obtained. Next, the analysis image was subjected to noise removal and inclination correction which are automatic correction processes by use of an analysis application.

Thereafter, an icon of surface roughness measurement was clicked to perform an analysis, thereby obtaining a three-dimensional surface property parameter (arithmetic mean height Sa).

Note that filter conditions (F calculation, S filter, L filter) in the analysis were not all set, and the analysis was carried out under the condition of nil.

The arithmetic mean height Sa was the average in three visual fields.

The results obtained are set forth in the column of “Roughened Ni surface Sa” of Table 4.

### Example 1

First, as the raw sheet to be the base material 20, a cold rolled steel sheet (260 μm in thickness) of a low carbon aluminum-killed steel having the following composition was prepared.

C: 0.04 wt %, Mn: 0.32 wt %, Si: 0.01 wt %, P: 0.012 wt %, S: 0.014 wt %, the balance: Fe and unavoidable impurities

Next, the prepared raw sheet was subjected to electrolytic degreasing and pickling by immersion in sulfuric acid, after which nickel plating was conducted under the following conditions, to form nickel plating layers having a target thickness of 3.0 μm and a nickel deposition amount of 26.7 g/m² on both surfaces (nickel plating step). Note that the conditions for the nickel plating were as follows.

### (Conditions of Ni Plating)

Bath composition: Watts bath
Nickel sulfate hexahydrate: 250 g/L
Nickel chloride hexahydrate: 45 g/L
Boric acid: 30 g/L
Bath temperature: 60° C.
pH: 4.0 to 5.0
Stirring: air stirring or jet stirring
Current density: 10 A/dm²

The nickel deposition amount was measured by use of an X-ray fluorescence device. Note that, at respective time points after the second heat treatment step described later and after the second rolling step, measurement by the X-ray fluorescence device was similarly conducted to determine nickel deposition amounts. Note that, at respective time points after the re-plating step in Examples 9 to 11 described later or after the roughened plating layer forming step, measurement was similarly conducted. As the X-ray fluorescence device, ZSX100e made by Rigaku Corporation was used.

Next, the steel sheet having the nickel plating layers formed as described above was subjected to a heat treatment by continuous annealing under the conditions of a heat treatment temperature of 780° C., a soaking time of 60 seconds, and a reducing atmosphere, to obtain a treated steel sheet (first heat treatment step). The thus obtained treated steel sheet is referred to as “e1.”

The treated steel sheet e1 was subjected to X-ray diffraction and measurement of the hydrogen permeation current density, the results being set forth in Table 1. In the treated steel sheet e1, the orientation index of the Fe₁Ni₁(220) plane obtained by X-ray diffraction was 0.42.

In other words, while it can be confirmed that iron-nickel diffusion layers had been formed on the treated steel sheet e1, the orientation index of the Fe₁Ni₁(220) plane was as small as 0.42, and, through it was confirmed that the hydrogen permeation current density was 3 μA/cm², the treated steel sheet e1 is thick and is not suitable for a battery in which a volume energy density is thought to be important.

Next, to obtain a thin foil, the treated steel sheet e1 was rolled, to obtain a rolled steel foil (first rolling step). The rolling conditions in this instance were cold rolling with a draft of 75% to 80%. The thus obtained rolled steel foil is referred to as “e2.”

The rolled steel foil e2 was subjected to X-ray diffraction and measurement of the hydrogen permeation current density, the results being set forth in Table 1. In the rolled steel foil e2, the orientation index of the Fe₁Ni₁(220) plane was 2.79.

In other words, in the rolled steel foil e2, it can be said that the characteristics in the case where the iron-nickel diffusion layers formed by the above-mentioned first heat treatment step are subjected to rolling are appearing.

Besides, the rolled steel foil e2 did not satisfy the formula (1); specifically, the left side of the formula (1) was 0.08, which is by far smaller than 0.5. In addition, the hydrogen permeation current density was 90 μA/cm², indicating largely lowered hydrogen barrier properties.

Next, the rolled steel foil e2 was subjected to annealing under the conditions of a soaking time of six hours at 560° C. and a total time of 80 hours, to obtain a surface treated steel foil (second heat treatment step). The thus obtained surface treated steel foil is referred to as “e3.”

The surface treated steel foil e3 was subjected to X-ray diffraction and measurement of the hydrogen permeation current density, the results being set forth in Table 1. In the surface treated steel foil e3, the nickel deposition amount was 5.8 g/m², and the orientation index of the Fe₁Ni₁(220) plane was 2.47.

In other words, it was made clear that the characteristics obtained upon the first rolling step remain even upon the second heat treatment step.

Then, as indicated in Table 1, the surface treated steel foil e3 satisfied the formula (1). In other words, the steel foil had such a configuration that the numerical value of the left side of the formula (1) was not less than 0.5. In addition, the hydrogen permeation current density was 39 μA/cm², indicating that the hydrogen barrier properties were recovered.

Next, the surface treated steel foil e3 was subjected to rolling with a draft of 10% to 15% (second rolling step). Note that the total draft calculated from the thickness before the first rolling step and the thickness after the second rolling step is 81.2%. The thus obtained surface treated steel foil is referred to as “e4.”

The surface treated steel foil e4 was subjected to X-ray diffraction and measurement of the hydrogen permeation current density, the results being set forth in Table 1. In addition, the nickel deposition amount was 5.0 g/m², and in the surface treated steel foil e4, the orientation index of the Fe₁Ni₁(220) plane was 3.34, and the thickness was 50 μm.

Then, as indicated in Table 1, the surface treated steel foil e4 satisfied the formula (1). In other words, the steel foil had such a configuration that the numerical value of the left side of the formula (1) was not less than 0.5.

In addition, the hydrogen permeation current density was 55 μA/cm², indicating that the hydrogen barrier properties were slightly lowered as compared to the hydrogen barrier properties upon the second heat treatment step, but since the draft in the second rolling step was less than 35%, the lowering in the hydrogen barrier properties was not as much as that due to the first rolling step.

From the above results, it was able to be confirmed that the orientation index of the Fe₁Ni₁(220) plane was not less than 1.0, and that a surface treated steel foil having good hydrogen barrier properties was obtained, since the steel foil satisfied the following formula (1).

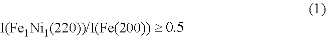

In addition, in the following, evaluation was conducted by varying the raw sheet thickness, the nickel deposition amount in the nickel plating step, the heat treatment conditions in the first heat treatment step, the rolling conditions in the first rolling step, and the annealing conditions in the second heat treatment step.

Besides, also for a sample having undergone the second rolling step and a sample having undergone the roughened nickel layer forming step, evaluation was conducted. For the respective samples, the results of X-ray diffraction measurement and measurement of the hydrogen permeation current density are set forth in Table 2.

Note that e3 in Table 1 confirmed in Example 1 is the same sample as that in Example 1-1 in Table 2, and the sample e4 is the same sample as that in Example 1-2 in Table 2.

### Example 2

First, a cold rolled steel sheet (thickness 200 μm) of a low-carbon aluminum-killed steel having the following chemical composition was prepared as a raw sheet to be the base material 20.

C: 0.04 wt %, Mn: 0.32 wt %, Si: 0.01 wt %, P: 0.012 wt %, S: 0.014 wt %, the balance: Fe and unavoidable impurities

Next, the thus prepared raw sheet was subjected to electrolytic degreasing and pickling by immersion in sulfuric acid, after which nickel plating was conducted to form nickel plating layers with a target thickness of 5.0 μm and a nickel deposition amount of 44.5 g/m² on both surfaces of the raw sheet (nickel plating step). Note that the nickel plating conditions were the same as those in Example 1, except for the deposition amount.

Subsequently, the steel sheet having the nickel plating layers formed as above was subjected to a heat treatment by continuous annealing under the conditions of a heat treatment temperature of 780° C., a soaking time of 40 seconds, and a reducing atmosphere (first heat treatment step), to obtain a treated steel sheet.

The treated steel sheet obtained as above was subjected to rolling (first rolling step), to obtain a rolled steel foil. The rolling conditions were cold rolling with a draft of 70% to 75%.

The rolled steel foil having undergone the above-mentioned first rolling was subjected to annealing under the conditions of a reducing atmosphere, a temperature of 560° C., a soaking time of six hours, and a total time of 80 hours (second heat treatment step). Upon the second heat treatment step, the nickel deposition amount was 12.3 g/m², the thickness of the surface treated steel foil was 58 μm, and the hydrogen permeation current density (oxidation current value) was 4.7 μA/cm². The results are set forth in Table 1.

### Example 3

The thickness of a cold rolled steel sheet as a raw sheet was 180 μm. A target thickness of nickel plating layers in the nickel plating step was 3.0 μm, and the nickel deposition amount was 26.7 g/m². The conditions for continuous annealing in the first heat treatment step were a temperature of 680° C. and a soaking time of 40 seconds. The draft in the first rolling step was 65% to 70%. Except for these points, a process similar to that in Example 2 was conducted.

A surface treated steel foil having undergone the second heat treatment step had a nickel deposition amount of 8.3 g/m², and a hydrogen permeation current density (oxidation current value) of 5.3 μA/cm². The results are set forth in Table 2.

### Example 4

A heat treatment temperature in the second heat treatment step was 620° C. Except for this point, a process similar to that in Example 3 was conducted.

A surface treated steel foil having undergone the second heat treatment step had a nickel deposition amount of 8.3 g/m², and a hydrogen permeation current density (oxidation current value) of 5.3 μA/cm². The results are set forth in Table 2.

### Example 5

A sample having undergone up to the second heat treatment step under the conditions same as those in Example 2 was subjected to rolling (second rolling step). The rolling conditions in the second rolling step were cold rolling with a draft of 10% to 15%. Note that the draft in the second rolling step is a draft calculated from the thicknesses of the sample across the second rolling step.

On the other hand, the total draft was 76.2%. Note that the total draft is a draft calculated from the thickness before the first rolling step and the thickness after the second rolling step.

A surface treated steel foil having undergone the second rolling step had a nickel deposition amount of 10.6 g/m², and a hydrogen permeation current density (oxidation current value) of 7.6 μA/cm². The results are set forth in Table 2.

### Example 6

A process similar to that in Example 5 was conducted, except that the thickness of a cold rolled steel sheet as a raw sheet was 180 μm, the conditions for continuous annealing as the first heat treatment were a temperature of 660° C. and a soaking time of 40 seconds, the draft in the first rolling was 65% to 70%, and the heat treatment temperature in the second heat treatment was 590° C. The total draft was 73.7%.

A surface treated steel foil having undergone the second rolling step had a nickel deposition amount of 11.7 g/m², and a hydrogen permeation current density (oxidation current value) of 3.0 μA/cm². The results are set forth in Table 2.

### Example 7

The target thickness of nickel plating layers in the nickel plating step was 3.0 μm, and the nickel deposition amount was 26.7 g/m². Except for these points, a process similar to that in Example 5 was conducted. The total draft was 75.7%.

A surface treated steel foil having undergone the second rolling step had a nickel deposition amount of 6.48 g/m², and a hydrogen permeation current density (oxidation current value) of 27.5 μA/cm². The results are set forth in Table 2.

### Comparative Example 1

A cold rolled steel sheet (thickness 50 μm) of a low-carbon aluminum-killed steel having the following chemical composition was prepared.

C: 0.04 wt %, Mn: 0.32 wt %, Si: 0.01 wt %, P: 0.012 wt %, S: 0.014 wt %, the balance: Fe and unavoidable impurities

The thus prepared cold rolled steel foil was subjected to electrolytic degreasing and pickling by immersion in sulfuric acid, after which nickel plating was conducted to form nickel plating layers with a target thickness of 0.5 μm and a nickel deposition amount of 4.5 g/m² on both surfaces of the steel foil. Note that the conditions for the nickel plating were the same as those in Example 1 except for the deposition amount.

The thus obtained surface treated steel foil was subjected to X-ray diffraction and measurement of the hydrogen permeation current density. As a result of the X-ray diffraction analysis, the presence of the iron-nickel alloy layer and Fe₁Ni₁ was not confirmed. The hydrogen permeation current density (oxidation current value) was 273.0 μA/cm². The results are set forth in Table 2.

### Comparative Example 2

A sample having undergone the steps up to the first rolling step under the conditions same as those in Example 1-1 (e3) was annealed (second heat treatment step). The heat treatment conditions in the second heat treatment step were a temperature of 600° C. and a soaking time of 60 seconds.

The thus obtained surface treated steel foil was subjected to X-ray diffraction and measurement of the hydrogen permeation current density. Though the presence of Fe₁Ni₁ was confirmed, the formula (1) was not satisfied. The nickel deposition amount was 5.82 g/m², and the hydrogen permeation current density (oxidation current value) was 100.0 μA/cm². The results are set forth in Table 2.

### Comparative Example 3

The thickness of a cold rolled steel sheet as a raw sheet was 200 μm. The target thickness of the nickel plating layers in the nickel plating step was 1.9 μm, and the nickel deposition amount was 16.91 g/m². The conditions for continuous annealing in the first heat treatment step were a temperature of 700° C. and a soaking time of 40 seconds, the draft in the first rolling conditions was 75% to 80%, and the second heat treatment conditions included a temperature of 480° C. Except for these points, a process similar to that in Example 2 was conducted. Although the presence of Fe₁Ni₁ was confirmed, the formula (1) was not satisfied. The hydrogen permeation current density (oxidation current value) was 80.0 μA/cm². The results are set forth in Table 2.

### Example 8

With respect to nickel plating layers in the nickel plating step, the target thickness was 5.0 μm and the nickel deposition amount was 44.5 g/m² on one surface side (Example 8-1). On the other surface side, the target thickness was 1.0 μm and the nickel deposition amount was 8.9 g/m² (Example 8-2). The draft in the first rolling was 65% to 70%, and the conditions for continuous annealing in the first heat treatment step were a temperature of 680° C. and a soaking time of 40 seconds. Except for these points, a process similar to that in Example 6 was conducted, to obtain a sample.

The thus obtained sample was rolled (second rolling step). The rolling conditions in the second rolling step were a temperature of room temperature and a draft of 10% to 15%. The total draft was 73.1%.

With respect to a surface treated steel foil having undergone the second rolling step, the nickel deposition amounts on the one surface side and the other surface side were respectively 12.0 g/m² (Example 8-1) and 2.4 g/m² (Example 8-2). The hydrogen permeation current densities (oxidation current values) measured with each of the surfaces as a detection surface were 15.0 μA/cm² in both Example 8-1 and Example 8-2. The results are set forth in Table 3.

### Example 9

A sample obtained under the conditions same as those in Example 6 was subjected to nickel plating (re-plating step) with a target thickness of 1.0 μm on each of both surface sides. The thus obtained surface treated steel foil was subjected to X-ray diffraction. In addition, the steel foil was subjected to measurement of the hydrogen permeation current density, without forming measurement nickel films. The hydrogen permeation current density (oxidation current value) was 3.0 μA/cm². The results are set forth in Table 4.

### Example 10

A sample produced under the conditions same as those in Example 6 was subjected to ground nickel plating (re-plating step) with a target thickness of 1.0 μm on each of both surface sides. The ground nickel plating conditions were as follows. Next, roughened nickel plating (roughened nickel layer forming step) was applied to one surface side under the following conditions. Note that the roughened nickel layer forming step included coating nickel plating.

(Ground nickel plating conditions)
Bath composition: nickel sulfate hexahydrate 250 g/L, nickel chloride hexahydrate 45 g/L, boric acid 30 g/L
   pH 4.2
   Bath temperature 60° C.
   Current density 10 A/dm²
   Plating time 30 seconds
      (Roughened nickel plating conditions)
Concentration of nickel sulfate hexahydrate in plating bath: 10 g/L
Concentration of nickel chloride hexahydrate in plating bath: 10 g/L
Concentration of chloride ions in plating bath: 3 g/L
Ratio between nickel ions and ammonium ions in plating bath: nickel ions/ammonium ions (weight ratio)=0.17
pH: 6
Bath temperature: 50° C.
Current density: 12 A/dm²
Plating time: 60 seconds

### (Coating Nickel Plating Conditions)

Bath composition: nickel sulfate hexahydrate 250 g/L, nickel chloride hexahydrate 45 g/L, boric acid 30 g/L
pH: 4.0 to 5.0
Bath temperature: 60° C.
Current density: 5 A/dm²
Plating time: 36 seconds

The thus obtained surface treated steel foil was subjected X-ray diffraction analysis of the roughened nickel layer side. In addition, the hydrogen permeation current density was measured, without forming measurement nickel films and with the roughened nickel layer as the detection side. The hydrogen permeation current density (oxidation current value) was 3.0 μA/cm². The results are set forth in Table 4.

### Example 11

A process similar to that in Example 10 was conducted, except that the plating time in the roughened nickel layer forming step was 85 seconds. The thus obtained surface treated steel foil was subjected to X-ray diffraction of the roughened nickel layer side. In addition, the hydrogen permeation current density was measured, with the roughened nickel layer as the detection side. The hydrogen permeation current density (oxidation current value) was 3.0 μA/cm². The results are set forth in Table 4.

TABLE 1

| | | | | | Hydrogen |
|---|---|---|---|---|---|
| | | | Fe1Ni1 | | permeation |
| | | Fe1Ni1 | (220) | | current |
| | Sample state | (220)/ | orientation | Fe(211)/ | density |
| Test No. | (step basis) | Fe(200) | index | Fe(200) | [μA/cm²] |
| e1 | Upon first heat | — | 0.42 | — | 3 |
| | treatment step | | | | |
| e2 | Upon first | 0.08 | 2.79 | — | 90 |
| | rolling step | | | | |
| e3 | Upon second heat | 0.58 | 2.47 | 2.08 | 39 |
| (Example | treatment step | | | | |
| 1-1) | | | | | |
| e4 | Upon second | 0.52 | 3.34 | 1.82 | 55 |
| (Example | rolling step | | | | |
| 1-2) | | | | | |

TABLE 2

| | Ni | FeNi alloy | | | | | Hydrogen |
|---|---|---|---|---|---|---|---|
| Example/ | deposition | layer | First rolling | | Fe1Ni1(220) | | permeation |
| Comparative | amount | thickness | draft | Fe1Ni1(220)/ | orientation | Fe(211)/ | current density |
| Example | g/m² | [μm] | [%] | Fe(200) | index | Fe(200) | [μA/cm²] |
| Example 1-1 (e3) | 5.8 | 2.2 | 75~80 | 0.58 | 2.47 | 2.08 | 39.0 |
| Example 1-2 (e4) | 5.0 | 2.2 | 75~80 | 0.52 | 3.34 | 1.82 | 55.0 |
| Example 2 | 12.3 | 2.4 | 70~75 | 1.69 | 2.23 | 4.15 | 4.7 |
| Example 3 | 8.3 | 2.3 | 65~70 | 1.31 | 2.55 | 4.68 | 5.3 |
| Example 4 | 8.3 | 2.3 | 65~70 | 2.95 | 2.36 | 3.43 | 5.3 |
| Example 5 | 10.6 | 2.4 | 70~75 | 1.18 | 3.70 | 2.04 | 7.6 |
| Example 6 | 11.7 | 2.3 | 65~70 | 1.51 | 3.30 | 3.52 | 3.0 |
| Example 7 | 6.5 | 2.2 | 70~75 | 1.01 | 3.63 | 1.83 | 27.5 |
| Comparative | 4.5 | — | 0.0 | — | — | 2.23 | 273.0 |
| Example 1 | | | | | | | |
| Comparative | 5.8 | 0.9 | 75~80 | 0.06 | 2.65 | 1.60 | 100.0 |
| Example 2 | | | | | | | |
| Comparative | 4.2 | 0.5 | 75~80 | 0.08 | 3.55 | 1.18 | 80.0 |
| Example 3 | | | | | | | |

TABLE 3

| | | FeNi alloy | First | | | | Hydrogen |
|---|---|---|---|---|---|---|---|
| Example/ | Ni deposition | layer | rolling | | Fe1Ni1(220) | | permeation |
| Comparative | amount | thickness | draft | Fe1Ni1(220)/ | orientation | Fe(211)/ | current density |
| Example | g/m² | [μm] | [%] | Fe(200) | index | Fe(200) | [μA/cm²] |
| Example 8-1 | 12/2.4 | 2.3 | 65~70 | 1.16 | 3.03 | 2.53 | 15.0 |
| Example 8-2 | 2.4/12 | 1.1 | 65~70 | 0.53 | 3.44 | 2.09 | 15.0 |

TABLE 4

| | | FeNi alloy | First | | | |
|---|---|---|---|---|---|---|
| Example/ | Ni deposition | layer | rolling | | Fe1Ni1(220) | |
| Comparative | amount | thickness | draft | Fe1Ni1(220)/ | orientation | Fe(211)/ |
| Example | g/m² | [μm] | [%] | Fe(200) | index | Fe(200) |
| Example 9 | 11.7 | 2.3 | 65~70 | 1.31 | 3.48 | 2.99 |
| Example 10 | 11.7 | 2.3 | 65~70 | 1.30 | 3.07 | 3.30 |
| Example 11 | 11.7 | 2.3 | 65~70 | 1.00 | 3.05 | 2.41 |

| | Metallic layer | | | | | |
|---|---|---|---|---|---|---|
| | | | | Total Ni | | Evaluation |
| | | Roughened | Coating | deposition | Roughened | Hydrogen |
| | Ground | Ni | Ni | amount | Ni | permeation |
| Example/ | Ni | deposition | deposition | with alloy | surface | current |
| Comparative | thickness | amount | amount | layer | Sa | density |
| Example | [μm] | [g/m²] | [g/m²] | [g/m²] | [μm] | [μA/cm²] |
| Example 9 | 1 | no data | no data | 20.6 | 0.147 | 3.0 |
| Example 10 | 1 | 11.6 | 5.3 | 37.5 | 0.619 | 3.0 |
| Example 11 | 1 | 15.1 | 5.3 | 41.0 | 0.893 | 3.0 |

It was confirmed that each of Examples had favorable hydrogen barrier properties. On the other hand, it was confirmed that Comparative Example 1 was not able to achieve the object in terms of hydrogen barrier properties.

Specifically, in every one of Examples 1 to 11, the steel foil obtained had such a structure that the orientation index of the (220) plane of Fe₁Ni₁ as a characteristic of re-rolling is not less than 1.0, satisfied the formula (1), and had such a structure that Fe₁Ni₁(220)/Fe(200) is not less than 0.5, so that good hydrogen barrier properties was able to be obtained. This is considered to be because, even if the iron-nickel diffusion layer was locally thinned upon re-rolling and iron was exposed, the exposed parts were restrained, and in the later steps, an iron-nickel alloy layer having a sufficient Fe₁Ni₁ alloy phase was able to be formed.

On the other hand, in the surface treated steel foil obtained by only nickel plating on a steel foil of Comparative Example 1, hydrogen barrier properties failed to be obtained. In addition, in Comparative Examples 2 and 3, the formula (1) was not satisfied, specifically, the left side of the formula (1) was less than 0.5, and the hydrogen barrier properties failed to be recovered. This is considered to be because the exposed parts of iron which were formed in the first rolling step failed to be alloyed in the second heat treatment step and remained after the second heat treatment step.

Further, in Examples in which Fe₁Ni₁(220)/Fe(200) was not less than 0.6 (Examples 2 to 12), the recovery of the hydrogen barrier properties was higher.

Furthermore, in Examples in which Fe(211)/Fe(200) was not less than 2.0 (Examples 2 to 6, 8-1, 8-2, 9 to 11), the hydrogen barrier properties were particularly favorable.

In addition, under a strong alkali environment in measurement of the hydrogen permeation current density in the present embodiment and in a state in which a potential of +0.4 V is applied on the hydrogen detection side, a peak indicative of dissolution does not appear, and the oxidation current as the background is stable, so that it can be said that the present embodiment also has liquid electrolyte resistance. Note that, even in a state in which the measurement nickel film is absent, the tendency of the oxidation current as the background was similar to the above.

Note that the present embodiment and each of Examples may variously be modified within such a scope as not to depart from the gist of the present invention.

In addition, while the surface treated steel foil in the above embodiment and Examples has been described to be used mainly for a current collector of a bipolar battery, this is not limitative. For example, the surface treated steel foil is applicable also to other uses such as a heat radiation material or an electromagnetic shielding material.

### INDUSTRIAL APPLICABILITY

As has been described above, the surface treated steel foil of the present invention is applicable to a variety of fields such as automobiles and electronic devices, and in the case where the surface treated steel foil of the present invention is used for in-vehicle batteries or the like, it is possible to contribute especially to reduction of fuel cost.

### REFERENCE SIGNS LIST

10: Surface treated steel foil
10a: First surface
10b: Second surface
20: Base material
30: Iron-nickel alloy layer
40: Metallic layer
50: Roughened nickel layer
Ch1: Potentiostat
Ch2: Potentiostat

1. A surface treated steel foil having a first surface and a second surface located on a side opposite to the first surface, the surface treated steel foil comprising:
a base material composed of a low carbon steel or an ultra low carbon steel; and
an iron-nickel alloy layer laminated on the base material on at least one surface side of the first surface side and the second surface side,
wherein Fe₁Ni₁ is contained as an alloy phase in the iron-nickel alloy layer,
an orientation index in X-ray diffraction of a (220) plane of Fe₁Ni₁ in the surface having the iron-nickel alloy layer is not less than 1.0, and
a ratio of a maximum value of diffraction intensity of the (220) plane of Fe₁Ni₁ and a maximum value of diffraction intensity of a Fe(200) plane satisfies a following formula (1).

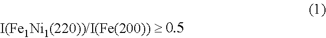

2. The surface treated steel foil according to claim 1, wherein a ratio of a maximum value of diffraction intensity of a (211) plane of Fe, among crystal planes of Fe contained in the iron-nickel alloy layer, and the maximum value of diffraction intensity of the Fe(200) plane satisfies a following formula (2).

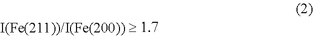

3. The surface treated steel foil according to claim 1,
wherein iron-nickel alloy layers are provided on both the first surface side and the second surface side of the base material,
Fe₁Ni₁ is contained as an alloy phase in the iron-nickel alloy layer on at least one surface side of the first surface side and the second surface side,
the orientation index in X-ray diffraction of the (220) plane of Fe₁Ni₁ in the surface having the iron-nickel alloy layer containing Fe₁Ni₁ is not less than 1.0, and
the ratio of the maximum value of diffraction intensity of the (220) plane of Fe₁Ni₁ and the maximum value of diffraction intensity of the Fe(200) plane satisfies the following formula (1).

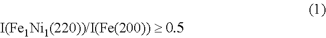

4. The surface treated steel foil according to claim 3, wherein a following formula (3) is satisfied in the surface having the iron-nickel alloy layer containing Fe₁Ni₁.

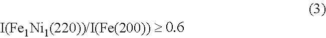

5. The surface treated steel foil according to claim 1, wherein a thickness of the surface treated steel foil as a whole is not more than 200 μm.

6. The surface treated steel foil according to claim 1, wherein a deposition amount of nickel in the iron-nickel alloy layers is 2.22 to 26.7 g/m² per one surface side.

7. The surface treated steel foil according to claim 1, further comprising:
a metallic layer formed on the iron-nickel alloy layer, the metallic layer being a nickel layer.

8. The surface treated steel foil according to claim 7, wherein a total of nickel deposition amounts in the iron-nickel alloy layer and the nickel layer is 2.22 to 53.4 g/m².

9. The surface treated steel foil according to claim 1, wherein a hydrogen permeation current density measured electrochemically is not more than 55 μA/cm²,
where the hydrogen permeation current density is an increment of an oxidation current measured on a hydrogen detection side when a potential of −1.5 V is applied on a hydrogen generation side under a condition where a potential on the hydrogen detection side is +0.4 V in a liquid electrolyte at 65° C. with a reference electrode for potentials on the hydrogen detection side and the hydrogen generation side being Ag/AgCl.

10. The surface treated steel foil according to claim 1 wherein a roughened nickel layer is formed at an outermost surface on at least one of the first surface side and the second surface side, and a three-dimensional surface property parameter Sa of the roughened nickel layer is 0.2 to 1.3 μm.

11. The surface treated steel foil according to claim 1, wherein the surface treated steel foil is for a current collector of a battery.

12. The surface treated steel foil according to claim 11, wherein the surface treated steel foil is for a current collector of a bipolar battery.

13. A surface treated steel foil for current collector having a first surface on which a hydrogen occluding alloy is disposed and a second surface located on a side opposite to the first surface, the surface treated steel foil comprising:
a base material composed of a low carbon steel or an ultra low carbon steel; and
an iron-nickel alloy layer that is laminated on the base material on at least one surface side of the first surface side and the second surface side and that restrains permeation or diffusion of hydrogen in the surface treated steel foil,
wherein Fe₁Ni₁ is contained as an alloy phase in the iron-nickel alloy layer,
an orientation index in X-ray diffraction of a (220) plane of Fe₁Ni₁ in the surface having the iron-nickel alloy layer is not less than 1.0, and
a ratio of a maximum value of diffraction intensity of the (220) plane of Fe₁Ni₁ and a maximum value of diffraction intensity of a Fe(200) plane satisfies a following formula (1). [chemical structure]
